(19) United States
(12) Patent Application Publication
(10) Pub. No.: US 2002/0160272 A1
(43) Pub. Date: Oct. 31, 2002

(54) Process for producing a modified electrolyte and the modified electrolyte

(75) Inventors: Hiromitsu Tanaka, Aichi-ken (JP); Arimitsu Usuki, Aichi-ken (JP); Masaya Kawasumi, Aichi-ken (JP); Yu Morimoto, Aichi-ken (JP); Naoki Hasegawa, Aichi-ken (JP); Mitsuru Nakano, Aichi-ken (JP); Atsushi Kamiya, Aichi-ken (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOYOTA CHUO, Kenkyusho (JP)

(21) Appl. No.: 10/079,873

(22) Filed: Feb. 22, 2002

(30) Foreign Application Priority Data
Feb. 23, 2001 (JP) 2001-047634

(51) Int. Cl. H01M 8/10; H01M 10/40

(52) U.S. Cl. 429/314; 429/189; 429/33

(57) ABSTRACT

A first process for producing a modified electrolyte consistent with the present invention comprises an amine treatment step of contacting a solid polymer electrolyte or a precursor thereof with an amine compound. Further, a first modified electrolyte consistent with the present invention consists essentially of what is obtained in such a process. A second process for producing the modified electrolyte consistent with the present invention includes a step of introducing, to a solid polymer compound having a functional group A, a first modifying agent comprising at least one functional group B capable of reacting with the functional group A thereby forming a first intermediate acid group; and the step also includes reacting the functional group A and the functional group B. Further, a second modified electrolyte consistent with the present invention comprises a solid polymer compound having side chains, at least one terminal acid group present at terminals of the side chains, and at least one intermediate acid group and/or reformed acid group present within the side chains identical with the side chains containing the terminal acid group.

### BACKGROUND OF THE INVENTION

1. Field of the Invention

The present invention concerns a process for producing a modified electrolyte and a modified electrolyte and, more in particular, it relates to a process for producing a modified electrolyte as well as a modified electrolyte suitable to an electrolyte membrane for use in fuel cells, water electrolysis apparatus, halogen hydracid electrolysis apparatus, sodium chloride electrolysis apparatus, hydrogen and/or oxygen concentrators, humidity sensors and gas sensors.

2. Description of the Related Art

Solid polymer electrolytes are solid polymer materials having electrolyte groups such as sulfonic groups in the polymer chains and since they have a property of strongly bonding with specific ions and selectively permeating cations or anions, they are utilized in various application uses, being formed into granules, fibers or membranes.

For example, a solid polymer fuel cell has a pair of electrodes on both surfaces of an electrolyte membrane in which a fuel gas containing hydrogen such as a modified gas is supplied to one electrode (fuel electrode) while an oxidant gas containing oxygen such as air is supplied to the other electrode (air electrode) and chemical energy generated upon oxidation of the fuel is taken out directly as electric energy. In the solid polymer fuel cell, a solid polymer electrolyte membrane having a proton conductivity is used as an electrolyte membrane.

Further, an SPE electrolytic method is a method of producing hydrogen and oxygen by electrolysis of water in which a solid polymer electrolyte membrane having proton conductivity is used instead of existent aqueous alkali solutions.

Known solid polymer electrolytes used in such application uses include, for example, non-crosslinked perfluoro polymer electrolytes typically represented by Nafion (registered trade mark of products manufactured by E.I. duPont de Nemours and Company). Since the perfluoro polymer electrolyte is highly chemically stable, it has been recommended as an electrolyte membrane used under severe conditions such as in fuel cells and SPE electrolysis.

Further, Journal of Fluorine Chemistry, vol. 72 (1995) pp 203 to 208 proposes a bis(perfluoroalkylsulfonyl)imide group as a novel acid group and discloses bis(perfluoroalkylsulfonyl)imide polymer having a structure similar to Nafion synthesized by copolymerization of perfluoro vinyl ether having two bissulfonylimide groups in ether moieties and tetrafluoro ethylene.

Further, U.S. Pat. No. 5,741,408, issued on April 21, 1998 to Freddy Helmer-Metzmann et al., discloses a crosslinked hydrocarbon polymer electrolyte membrane obtained by introducing a sulfonyl halide group into an aromatic polyether ketone, by reacting the introduced sulfonyl halide group with an UV-curing type amine crosslinker, and then, by conducting crosslinking reaction by the amine crosslinker.

Further, the present applicant discloses, in Japanese Patent Unexamined Publication No. 2000-188013, a highly heat resistant polymer electrolyte in which a perfluoro polymer compound is crosslinked by way of a strongly acidic crosslinking group comprising, for example, bissulfonyl imide, sulfonylcarbonyl imide, biscarbonyl imide or bissulfonyl methylene.

It has been known that the solid polymer fuel cell increases the power generation efficiency as the working temperature of the cell is higher. Further, a platinum series electrode catalyst is contained in electrodes bonded on both surfaces of the solid polymer electrolyte, and platinum is poisoned even with a small amount of carbon monoxide to lower the output of the fuel cell. Moreover, it has been known that the poisoning of the electrode catalyst by carbon monoxide increases more remarkably with decreasing temperature.

In view of the above, in the solid polymer fuel cell using a gas containing a slight amount of carbon monoxide such as a methanol reformed gas as a fuel gas, it has been desired to increase the working temperature in order to increase the efficiency and reduce the poisoning of the electrode catalyst with carbon monoxide.

Further, in the electrolysis of water, it has been known that the total energy required for the electrolysis of water does not change considerably depending on the temperature, but the minimum voltage required for the electrolysis of water, that is, the theoretical decomposion voltage, is lower as the temperature is higher. Therefore, if it is possible to supply a heat energy from the outside to the system and conduct electrolytic reaction at a high temperature, consumption of expensive electric energy can be reduced, which is advantageous in view of the efficiency.

Further, any of the existent solid polymer electrolytes requires water for developing the proton conductivity. Accordingly, in the solid polymer fuel cell, when the operation condition is in a dry condition, membrane resistance increases due to the drying of the electrolyte membrane to lower the output. In the existent solid polymer fuel cells, this is avoided by humidification of the electrolyte membrane using auxiliary equipment. However, the humidification with auxiliary equipment lowers the efficiency of the fuel cell, and increases the scale of the system. Therefore, in the fuel cell, there have been demands for an electrolyte membrane that shows high electric conductivity even under low humidity/high temperature condition in order to attain a high cell performance.

However, the perfluoro polymer electrolyte typically represented by Nafion has low heat resistance since it is not crosslinked and has a property of creeping at 130° C. or higher near the glass transition temperature. Therefore, when the perfluoro polymer electrolyte is used for a fuel cell or an SPE electrolysis apparatus, it is necessary that the working temperature is 100° C. or lower. If this is the case, the electrolyte cannot be used at high temperatures, and it is disadvantageous in preventing the electrode catalyst from being poisoned by carbon monoxide and in view of efficiency.

Further, in the fuel cell using the electrolyte membrane synthesized from a monomer having an electrolyte group such as Nafion, since the electric conductivity of the electrolyte membrane is insufficient, no high cell performance is obtained under low humidity/high temperature condition. On the other hand, when the content of the monomer having an electrolyte group is increased in order to improve the electric conductivity of the electrolyte membrane, crystallinity of the main chain is lowered. Thus, this results in a problem that the strength of the electrolyte membrane is lowered or the electrolyte membrane swells or solubilizes remarkably in water and its shape can no more be maintained.

Further, when the bis(perfluoroaklylsulfonyl)imide polymer as disclosed in Journal of Fluorine Chemistry, vol. 72 (1995), pp 203 to 208 is used, since perfluoro vinyl ether is bulky compared with tetrafluoro ethylene, there is a concern that no sufficient molecular weight is obtained by copolymerization, which might result in lack of membrane strength.

Further, since the bis(perfluoroalkylsulfonyl)imide polymer is not crosslinked, it involves a problem in heat resistance as with the case of Nafion. One possible solution to the problem may be to introduce a crosslink structure upon copolymerization of the imide polymer. However, when the crosslink structure is introduced upon copolymerization, the polymer becomes insoluble, making it difficult to form the polymer into a membrane or the like, so that no homogeneous membrane can be obtained.

Further, the method of crosslinking by the use of the UV-curing type amine crosslinker, as disclosed in U.S. Pat. No. 5,741,408, involves a problem that the electric conductivity lowers as the crosslinking density increases, because the electrolyte groups are consumed by the reaction with the crosslinker.

On the other hand, in the highly heat resistant polymer electrolyte proposed by the present applicant, since the perfluoro polymer electrolyte is crosslinked by way of the strongly acidic crosslinking group, the strength can be improved without greatly decreasing the amount of the electrolyte groups. However, in order to further enhance the performance of an electrochemical device used under severe conditions such as in fuel cells or an SPE electrolysis apparatus, it has been desired to further improve the heat resistance, the strength and the electric conductivity of the electrolyte used for the device.

### SUMMARY OF THE INVENTION

The present invention has been achieved in view of the situations described above and it has an object to overcome the foregoing problems and provide a process for producing a modified electrolyte excellent in heat resistance, strength and electric conductivity, as well as such a modified electrolyte.

Another object of the present invention is to provide a process for producing a modified electrolyte capable of maintaining high electric conductivity, even when a crosslinking density is increased, as well as such a modified electrolyte.

Further, another object of the present invention is to provide a process for producing a modified electrolyte having high performance even when it is applied to an electrochemical device used under severe conditions, as well as such a modified electrolyte.

Additional objects and advantages of the invention are set forth in the following description, are obvious from the description, or may be learned by practicing the invention. The objects and advantages of the invention may be realized and attained by means of instrumentalities and combinations particularly pointed out in the claims.

A first process for producing a modified electrolyte according to the present invention in order to solve the problems has a feature that it comprises an amine treatment step of contacting a solid polymer electrolyte or a precursor thereof with an amine compound.

In a preferred embodiment, a heat treatment step of heating the solid polymer electrolyte or the precursor thereof is further provided after the amine treatment step, preferably. Further, in a preferred embodiment, a base treatment step of contacting the solid polymer electrolyte or the precursor thereof with a base is further provided after the amine treatment step, preferably.

In addition, a first modified electrolyte according to the present invention consists essentially of what is produced in such a process.

The first process for producing a modified electrolyte according to the present invention provides a modified electrolyte excellent in durability, heat resistance, and high temperature creep resistance with electric conductivity kept high since it comprises the amine treatment step.

Further, a second process for producing a modified electrolyte according to the present invention has a feature that it comprises a first step of introducing, to a solid polymer compound having a functional group A, a first modifying agent comprising: at least one functional group B capable of reacting with the functional group A, thereby forming a first intermediate acid group; and at least one functional group C capable of forming a terminal acid group or a second intermediate acid group, and that the first step also includes reacting the functional group A with the functional group B.

A preferred embodiment may further comprises a second step of: introducing, to the solid polymer compound having been reacted with the first modifying agent, a second modifying agent comprising: at least one functional group D capable of reacting with the first or second intermediate acid group; and at least one functional group E capable of forming a terminal acid group or a third intermediate acid group, and the second step also includes reacting the first or second intermediate acid group with the functional group D.

Further, a second modified electrolyte according to the present invention has a feature that it comprises a solid polymer compound having side chains, at least one terminal acid group present at the terminal ends of the side chains, and at least one intermediate acid group and/or modified acid group present within the side chains identical with the side chains containing the terminal acid group.

In a preferred embodiment, the intermediate acid group is preferably at least one selected from the group consisting of a bissulfonyl imide group, a sulfonyl carbonyl imide group, and a biscarbonyl imide group. Further in a preferred embodiment, the terminal acid group is preferably at least one selected from the group consisting of a sulfonic acid group, a carboxylic acid group, and a phosphonic acid group.

Further in a preferred embodiment, a crosslinking group for crosslinking the solid polymer compounds to one another may further be provided. Further, in a preferred embodiment, the crosslinking group is preferably at least one selected from the group consisting of a bissulfonyl imide group, a sulfonylcarbonyl imide group, and a biscarbonyl imide group.

Since plural acid groups are introduced into one side chain constituting the solid polymer compound in the modified electrolyte according to the present invention, the modified electrolyte shows higher electric conductivity compared with existent solid polymer electrolytes each having a similar structure of the main chain and one acid group introduced into the side chain. Further, the amount of acid groups in the entire electrolyte can be controlled depending on the number of acid groups introduced into the side chains, and the introduction of the acid groups does not change the structure of the main chain. Therefore, electric conductivity of the modified electrolyte can be improved without deteriorating crystallinity in the main chain that contributes to the strength of the modified electrolyte.

Further, when a crosslink structure is further introduced to the modified electrolyte to which the terminal acid group and the intermediate acid group and/or modified acid group have been introduced into the same side chains, flows of molecules at high temperatures are suppressed, thereby greatly improving high temperature creep resistance. Therefore, when this is used in various kinds of electrochemical devices used at high temperatures, the working temperature of the device can be increased, thereby improving efficiency outstandingly. Further, when the modified electrolyte is used as an electrolyte membrane for use in a fuel cell, it can provide a fuel cell that operates stably even under the condition of low humidity and high temperatures.

The modified electrolyte having such a structure can be produced by introducing, to the solid polymer compound having the functional group A, a first modifying agent comprising at least one functional group B capable of reacting with the functional group A thereby forming a first intermediate acid group and at least one functional group C capable of forming a terminal acid group or a second intermediate acid group, and by reacting the functional group A with the functional group B.

### DESCRIPTION OF THE ACCOMPANYING DRAWINGS

The drawings appended to the specification and constituting a portion of the specification illustrate examples of the invention which is useful, in conjunction with the specification, for explaining the purposes, advantages and the principles of the invention, wherein:

FIG. 1 is a conceptional view for a modified electrolyte according to a second embodiment of the present invention;

FIGS. 2A to 2F are conceptional views explaining a relation between the amount of acid groups introduced into side chains and the thickness of a conductive path in the modified electrolyte shown in FIG. 1;

FIG. 3 is a graph showing a relation between a nitrogen molar fraction: Nₛᵤₗ(%) to the total number of sulfonic acid groups contained in the modified electrolyte according to a first embodiment of the present invention, and creep elongation in one minute and electric conductivity;

FIG. 4 is a graph showing a nitrogen density distribution over a cross section of the modified electrolyte according the first embodiment of the present invention to which an amine treatment has been applied using LBTMSA;

FIG. 5 is a graph showing a nitrogen density distribution over a cross section of the modified electrolyte according to the first embodiment of the present invention to which an amine treatment has been applied using ammonia; and

FIG. 6 is a graph showing a relation between the cell temperature and the output voltage of fuel cells using the electrolyte according to a second embodiment of the present invention and using an existent solid polymer electrolyte.

### DESCRIPTION OF PREFERRED EMBODIMENTS

Preferred embodiments according to the present invention are to be described in details. The process for producing a modified electrolyte according to a first embodiment of the present invention comprises an amine treatment step.

The amine treatment step is to be described. The amine treatment step is a step of contacting a solid polymer electrolyte or a precursor thereof and an amine compound.

In this embodiment, the solid polymer electrolyte may be a hydrocarbon polymer electrolyte containing only the C—H bonds in the polymer chain, or a fluoro polymer electrolyte containing C—F bonds in the polymer chain.

Further, the fluoro polymer electrolyte may be an electrolyte in which electrolyte groups are bonded to the main chain or side chains of a polymer compound containing both C—F bonds and C—H bonds in the polymer chain, or an electrolyte in which electrolyte groups are bonded to the main chain or the side chains of a polymer compound containing C—F bonds and not containing C—H bonds (hereinafter referred to as “perfluoro polymer compound”) (such an electrolyte will hereinafter be referred to as “perfluoro polymer electrolyte”). The perfluoro polymer electrolyte may also contain C—Cl bonds or other bonds (for example, —O—, —S—, —C(≡O)—, —N(R)—), in addition to C—F bonds.

In this embodiment, the precursor of the solid polymer electrolyte means those having a structure in which electrolyte groups contained in a solid polymer electrolyte are substituted with functional groups capable of forming electrolyte groups through derivation caused by chemical reaction (such a functional group will hereinafter be referred to as “electrolyte group precursor”).

The perfluoro polymer compound may preferably include, polytetrafluoroethylene, tetrafluoroethylene-perfluoroalkylvinyl ether copolymer, tetrafluoroethylene-hexafluoropropylene copolymer, tetrafluoroethylene-hexafluoropropylene-perfluoroalkylvinyl ether copolymer, and polychlorotrifluoroethylene.

Further, the electrolyte or the electrolyte group precursor (shown with “*”) may preferably include: —SO₃H; —SO₂F*; —SO₂Cl*; —SO₂Br*; —SO₃Na; —SO₃K; —SO₃Li; —SO₃Mg; —SO₃Ca; —CO₂H; —COF*; —COCl*; —COBr*; —CONa; —COK; —COLi; —COMg; —COCa; —PO₃H₂; ≡PO₂H; —OP(O₂H)O—; —OPO₃H₂; —OPOCl₂*; —OPOF₂*; —OPOBr₂*; —POCl₂*; —POF₂*; —POBr₂*; —OP(OCl)O—*; —OP(OF)O—*; —OP(OLi)O—; carboxylate ester*; sufonate ester*; phosphate ester*; carboxylic acid anhydride*; sulfonic acid anhydride*; phosphoric acid anhydride*; and a mixture of carboxylic acid, sulfonic acid, and phosphoric acid anhydrides*.

There is no particular restriction on the structure of the solid polymer electrolyte or the precursor thereof used herein, and its polymer chain may have either a linear structure or a branch structure.

For obtaining a modified electrolyte excellent in heat resistance and oxidation resistance, the solid polymer electrolyte or the precursor thereof is preferably perfluoro polymer electrolyte or the precursor thereof having —SH₃H (sulfonic acid group) or —SO₂F (sulfonyl fluoride group) as the electrolyte group or the electrolyte group precursor in its chemical structure (particularly, in the side chain), such as Nafion (registered trade mark) or the precursor thereof manufactured by E. I. DuPont de Numours and Company. Particularly, the sulfonyl fluoride group is preferred as the electrolyte group precursor since the creep resistance can be improved easily by the amine treatment as described later.

“Amine compound” used in the amine treatment step in this embodiment means a compound in which hydrogen atoms of ammonia are substituted with 0 to three substituents.

The substituent in this case may preferably include, an alkyl group, an aryl group, an allyl group, an alkene group, an alkine group, an alkoxy group, a hydroxy group, a hydroxyl group, a hydroxylate group, a thiocarboxy group, a dithiocarboxy group, a sulfo group, a sulfino group, a sulfeno group, an oxycarbonyl group, a haloformyl group, a carbamoyl group, a hydrazinocarbonyl group, an amidino group, a cyano group, an isocyan group, a cyanate group, an isocyanate group, a thiocyanate group, an isothiocyanate group, a formyl group, an oxo group, a thioformyl group, a thioxo group, a mercapto group, an amino group, an imino group, a hydrazino group, an aryloxy group, a sulfide group, a halogen group, a nitro group, and a silyl group.

Further, the substituent may be a metal, for example, Li, Na, K, Rb, Cs, Fr, Be, Mg, Ca, or Ba. The amine compound with such a substituent is referred to as a metal amide.

Among all, as the amine compound, it may be preferred to use ammonia, alkali metal(bistrimethylsilyl)amide, sodium amide, or a primary amine compound which is an amine compound in which one hydrogen atom of ammonia has been substituted with any of the above-described substituents.

The primary amine compound used for the amine treatment may preferably include, 1-hexylamine, ethylamine, butylamine, pentylamine, heptylamine, nonylamine, decylamine, perfluoromethylamine, perfluoroethylamine, perfluorobutylamine, perfluoropentylamine, and perfluoroheptylamine.

More preferably, ammonia may be used preferably as it is as the amine compound.

The method of contacting the solid polymer electrolyte or the precursor thereof with the amine compound may preferably include, a method of directly contacting a solid polymer electrolyte or a precursor thereof with an amine compound, a method of dissolving an amine compound in an appropriate solvent and contacting the same with a solid polymer electrolyte or a precursor thereof, and a method of exposing a solid polymer electrolyte or a precursor thereof to a vapor of an amine compound.

Further, there is no particular restriction on the solvent for dissolving the amine compound so long as it dissolves the amine compound, but those dissolving the amine compound by 10 mg/L or more are preferred. The solvent having high solubility may preferably include, fluoro type R113 or AK225.

The temperature upon amine treatment is preferably within a range from −30° C. to 200° C. The treatment rate is lowered remarkably by degradation in the molecular motion in the perfluoro polymer electrolyte at temperatures lower than −30° C., whereas decomposition of the perfluoro polymer electrolyte is caused at temperatures higher than 200° C., both of which are not preferred.

Further, the contact time and the addition amount of the amine compound can properly be adjusted depending on the kind of the amine compound within the boundaries of improving the creep resistance and not remarkably lowering the electric conductivity, with no particular restriction.

When the amine treatment is applied to a solid polymer electrolyte or a precursor thereof, part of the solid polymer electrolyte or the precursor thereof is crosslinked by the amine compound. The process for producing the modified electrolyte according to the present invention may further comprise a step for promoting the crosslinking caused by the amine compound after the amine treatment step.

This kind of step may preferably include, a heat treatment step and a base treatment step. One or both of the heat treatment step and the base treatment step may be conducted. When both of the heat treatment and the base treatment are conducted, the base treatment may be conducted after the heat treatment, or the heat treatment may be conducted after the base treatment.

Particularly, when the amine treatment, the base treatment and the heat treatment are conducted in this order to the solid polymer electrolyte or the precursor thereof, it provides an advantage that the heat resistance and the creep resistance can be improved with almost no decrease in the electric conductivity.

The heat treatment step is a step of heating a solid polymer electrolyte or a precursor thereof which has been in contact with an amine compound.

This step is preferably conducted at a heating temperature within a range of 40° C. to 200° C. The reaction rate is remarkably low at temperatures lower than 40° C., whereas decomposition of the solid polymer electrolyte occurs at temperatures higher than 200° C., both of which are not preferred. For attaining a high reaction rate, it is preferred to conduct heating near the softening point of the solid polymer electrolyte or the precursor thereof (in a range from 100 to 150° C. in the case of Nafion).

Further, the heating time may be adjusted properly depending on the addition amount, the kind, and the treatment time of the amine compound within the boundaries of improving the creep resistance and not remarkably lowering the electric conductivity, with no particular restriction.

The base treatment step is a step of contacting the solid polymer electrolyte or the precursor thereof, which has been in contact with the amine compound, further with the base.

The method of contacting the solid polymer electrolyte or the precursor thereof with the base may preferably include: a method of directly contacting the solid polymer electrolyte or the precursor thereof with a base; a method of dissolving a base in an appropriate solvent and contacting the same with a solid polymer electrolyte or a precursor thereof; and a method of exposing a solid polymer electrolyte or a precursor thereof to a vapor of a base.

Further, there is no particular restriction on the solvent for dissolving the base so long as it dissolves the base, but those dissolving the base by 10 mg/L or more are preferred. The solvent having high solubility may include, for example, a fluoro type R113 or AK225, preferably.

Further, the base treatment time may be adjusted properly depending on the addition amount, the kind, and the treatment temperature of the base within the boundaries of improving the creep resistance and not remarkably lowering the electric conductivity, with no particular restriction.

The base used in the base treatment step may preferably include: amine compounds such as trimethylamine, triethylamine, pyridine, DBU (1,8-diazabicyclo[5.4.0]-7-undecane), or DBN (1,5-diazabicyclo[4.3.0]non-5-ene);

metal base such as sodium hydroxide, lithium hydroxide, calcium hydroxide, aluminum hydroxide, potassium hydroxide, sodium carbonate, potassium carbonate, sodium hydrogen carbonate, or sodium alkoxide;

metal hydrides such as sodium hydride, potassium hydride, calcium hydride, lithium aluminum hydride, or sodium borohydride; and

organic metal compounds such as butyl lithium, sodium cyclopentadienide, or phenyl lithium.

According to the process for producing the modified electrolyte of this embodiment, a modified electrolyte in which the content of nitrogen derived from the amine compound relative to the total number of electrolyte groups or electrolyte group precursors in the solid polymer electrolyte (hereinafter referred to as “nitrogen molar fraction N (%)”) is 0.1% or more and 85% or less.

In a case where the nitrogen molar fraction N(%) is less than 0.1%, there is less effect of improving the durability and the heat resistance since the amount of crosslinking formed among the polymer chains is insufficient. On the other hand, when it exceeds 85%, it is difficult to use the resultant as the electrolyte since the amount of the electrolyte groups is remarkably decreased.

Further, in a case of a solid polymer electrolyte membrane obtained by molding the resultant modified electrolyte into a membrane shape, it is preferred that the nitrogen molar fraction N(%) per unit volume at each position in the direction of the membrane cross section (hereinafter referred to as nitrogen density n(%)) is as uniform as possible over the membrane cross section. Further, the maximum value nₘₐₓ for the nitrogen density n(%) is preferably within a range of 0.1% or more and 50% or less.

If the nitrogen derived from the amine compound is distributed unevenly in the membrane, that is, if there exist peaks locally in the distribution of the nitrogen density n(%), some portion of the membrane contains a significantly small amount of electrolyte groups, and the electric conductivity is lowered accordingly, which is not preferred.

The distribution of the nitrogen density n(%) can be controlled by various conditions such as the amount and the kind of the amine compound used in the amine treatment step. For obtaining a modified electrolyte in which the distribution of the nitrogen density n(%) is uniform, it is preferred to use an amine compound for the amine treatment step of which diffusion rate in the solid polymer electrolyte or the precursor thereof is higher than its reaction rate with the solid polymer electrolyte or the precursor thereof.

When the amine treatment is conducted by using an amine compound having a diffusion rate lower than the reaction rate, reaction take places on the surface of the solid polymer electrolyte or the precursor thereof before the amine compound permeates the inside of the solid polymer electrolyte or the precursor thereof. Consequently, the distribution of the nitrogen density n(%) becomes uneven, thus resulting in a portion where the electric conductivity is lowered locally, which is not preferred.

The distribution of the nitrogen density n(%) can be evaluated by the distribution of the nitrogen atoms derived from the amine compound and the distribution of the physical properties of the resultant modified electrolyte (for example, distribution of a modulus of elasticity, a creep characteristic, or electric conductivity).

Further, optimizing the conditions for the amine treatment condition, the base treatment condition, and/or heat treatment condition provides a modified electrolyte in which the maximum value nₘₐₓ of the nitrogen density n(%) across the cross section of the membrane is within a range of 0.1% or more and 50% or less, and in which the conductivity in the direction perpendicular to the membrane is 0.001 S/cm or more, preferably, 0.05 S/cm or more.

As has been described above, the process for producing the modified electrolyte according to this embodiment can suppress the flow of molecules at high temperatures while maintaining the electric conductivity high, because the process comprises the amine treatment step. Accordingly, deformation caused by softening in a high temperature region and creep occurring in long-duration use can be inhibited, by which the heat resistance and high temperature creep resistance are improved remarkably. Further, the process according to the present invention may be applied to the perfluoro solid polymer electrolyte or the precursor thereof, to obtain a modified electrolyte excellent in oxidation resistance at high temperatures.

The reason why the heat resistance and the durability can be improved while maintaining high electric conductivity remains uncertain, but it may be considered that the heat resistance and the high temperature creep resistance are improved because either covalent or ionic crosslinking caused by the amine compound is formed in a portion of the electrolyte groups or the electrolyte group precursors in the solid polymer electrolyte.

Further, it may be considered that the high electric conductivity is maintained because electrons that contribute to the bonding of hydrogen atoms are moved at the crosslinked point, being attracted by a fluoro carbon having electron attractivity, and because hydrogen atoms thus become more prone to be released as protons.

Further, it may also be considered that, if the base treatment is provided after the amine treatment, the base promotes crosslinking reaction to form crosslinking efficiently. Likewise, if the heat treatment is provided after the amine treatment, the heating promotes crosslinking reaction to form crosslinking efficiently.

It may be considered that, particularly, when the amine treatment, the base treatment and the heat treatment are conducted in this order, synergetic effects of those treatments yield significant improvements in the heat resistance and the high temperature creep resistance with even more efficiency while maintaining the electric conductivity high.

Accordingly, in a case of using the modified electrolyte obtained in the process according to the present invention, for example, in a solid polymer type fuel cell, the cell operates stably even under a high temperature condition (120° C. or higher depending on the composition of the modified electrolyte), and the efficiency can be improved outstandingly. In addition, decrease in voltage caused by poisoning of the electrode catalyst by carbon monoxide, which is a problem in a methanol reformed fuel cell can be suppressed greatly by such a high temperature operation.

Next, a modified electrolyte and a process for producing a modified electrolyte according to a second embodiment of the present invention are to be explained. The modified electrolyte according to this embodiment comprises solid polymer compounds, terminal acid groups, and intermediate acid groups and/or modified acid groups.

At first, the solid polymer compound is to be explained. The solid polymer compound constitutes a main portion of a modified electrolyte according to this embodiment and has a main chain that contributes to the strength of the modified electrolyte and side chains bonded to the main chain. The structure of the side chain may have either a linear or branch structure, with no particular restriction.

The solid polymer compound may be a fluoro polymer compound containing C—F bonds in the polymer chains or a hydrocarbon type polymer compound containing only the C—H bonds in the polymer chains. Further, the fluoro compounds may be either those having both C—F bonds and C—H bonds in the polymer chains (hereinafter referred to as “fluoro-hydrocarbon type polymer compound”), or those containing C—F bonds and not containing C—H bonds in the polymer chains (hereinafter referred to as “perfluoro polymer compound”). The fluoro polymer compound may also contain, in addition to the C—F bonds, C—Cl bonds and other bonds (for example, —O—, —S—, —C(≡O) —, —N(R) —, etc.).

Further, the hydrocarbon type polymer compounds may be either those not having aromatic rings in the polymer chains (hereinafter referred to as “aliphatic hydrocarbon type polymer compound”), or those having aromatic rings in any of the polymer chains (hereinafter referred to as “aromatic hydrocarbon type polymer compound”). Further, the aromatic hydrocarbon type polymer compounds may be either those having an alkylene chain (—(CH₂)ₙ—, n≧1) or a branched carbon structure (for example, —CHCH₃—, —C(CH₃)₂—etc.) in part of the bonding chains (such a compound will hereinafter be referred to as “partial aromatic hydrocarbon type polymer compound”), or those not containing an alkylene chain or a branched carbon structure in the bonding chains (such a compound will hereinafter be referred to as “whole aromatic hydrocarbon type polymer compound”).

Among them, the fluoro polymer compound is excellent in heat resistance and oxidation resistance since they have C—F bonds. Further, as will be described later, the intermediate acid group functions as a strong acid group by the interaction with the perfluoro skeleton. Therefore, for obtaining a modified electrolyte having heat resistance, oxidation resistance, and high electric conductivity, it is preferred to use a fluoro polymer compound, particularly, a perfluoro polymer compound as the solid polymer compound.

Further, among the hydrocarbon type polymer compounds, in the aromatic hydrocarbon type polymer compound, side chains having the acid groups can be introduced relatively easily. Therefore, for obtaining a modified electrolyte having high electric conductivity, it is preferred to use an aromatic hydrocarbon type polymer compound, particularly, a whole aromatic hydrocarbon type polymer compound as the solid polymer compound.

The modified electrolyte according to this embodiment has a feature in that plural acid groups are introduced into one side chain constituting the solid polymer compound. Therefore, high electric conductivity can be obtained even if the number of side chains bonded to the main chain is relatively small. Further, the total amount of acid groups that can be introduced into the entire electrolyte increases with the number of side chains bonded to the main chain.

Then, the terminal acid group is to be explained. The terminal acid group is an acid group bonded to the terminal end of the side chain. The terminal acid group may be bonded to the terminal end(s) of a portion of the side chains, or may be bonded to the terminal ends of all of the side chains constituting the solid polymer compound. In a case where the side chain has a branch structure, the terminal acid group may be bonded to the terminal end of one of the branched chains, or may be bonded to the terminal ends of a plurality of the branched chains. Generally, the electrolyte shows higher electric conductivity as the number of side chains to which the terminal acid groups are bonded and/or the number of terminal acid groups bonded to the side chains are/is larger.

Specifically, the terminal acid group may preferably include, a sulfonic acid group, a carboxylic acid group, and a phosphonic acid group. In a case where plural terminal acid groups are bonded to one side chain, all of such terminal acid groups may be identical with one another, or different kinds of terminal acid group may be combined. Further, the kind of terminal acid group may vary from one side chain to another.

Then, the intermediate acid group and the modified acid group are to be explained. The intermediate acid group is an acid group that constitutes a portion of the bonding chain in the side chain. Further, the modified acid group is an acid group in which a portion of elements constituting the intermediate acid group is substituted with at least one atom group having an acid group. In this case, there is no particular restriction on the acid group in the atom group; it may have the structure identical with that of the terminal acid group, the intermediate acid group, or the modified acid group described above. Further, the atom group may have either a linear or branch structure, and may further be either a fluoro or hydrocarbon type.

Further, this embodiment has a feature that at least a portion of the intermediate acid groups or the modified acid groups is present in the side chain identical with the side chain in which at least one terminal acid group is present. In this case, a portion of the side chains constituting the solid polymer compound may be side chains having both of the terminal acid group and the intermediate acid group or the modified acid group (hereinafter referred to as “multifunctional side chain”) or all of the side chains may be multifunctional side chains.

Further, the multifunctional side chain may have one intermediate acid group or modified acid group, or may have a plurality of intermediate acid groups and/or modified acid groups. Generally, the electrolyte shows higher electric conductivity as the number of multifunctional side chains and/or the number of terminal acid groups, intermediate acid groups, or modified acid groups bonded to the multifunctional side chains are/is larger. Further, a modified electrolyte having an electric conductivity of 0.05 S/cm or more can be obtained by properly controlling the kind of terminal acid group, intermediate acid group, and modified acid group, as well as the amount of those acid groups to be introduced into the solid polymer compound.

Further, in a case where a plurality of intermediate acid groups and/or modified acid groups are bonded to one multifunctional side chain, all of the acid groups may be of one kind, or different kinds of acid group may be combined. -Further, the kind of intermediate acid group and/or modified acid group may vary from one multifunctional side chain to another.

The intermediate acid group may preferably include, a bissulfonyl imide group (—SO₂—NH—SO₂—), a sulfonyl carbonyl imide group (—CO—NH—SO₂—), and a biscarbonyl imide group (—CO—NH—CO—). The modified acid group may preferably include, those in which hydrogen of the bissulfonyl imide group, sulfonyl carbonyl imide group, or biscarbonyl imide group is substituted on a perfluoroalkylene chain having sulfonic acid groups, and the like.

In a case where the intermediate acid group is the bissulfonyl imide group, the sulfonyl carbonyl imide group, or the biscarbonyl imide group described above, it functions as the acid group even if the both ends thereof are bonded to the hydrocarbon skeleton. However, in a case where one end or both ends of the intermediate acid group are bonded to the perfluoro skeleton, the intermediate acid group functions as a strong acid group to provide the modified electrolyte with high electric conductivity. This is because electrons that contribute to N—H bonds move toward the perfluoro skeleton, being attracted by F having large electro-negativity, whereby H bonded to N becomes prone to be released as a proton.

A process for producing a modified electrolyte according to this embodiment is to be explained. The modified electrolyte according to this embodiment can be obtained by reacting a solid polymer compound having a functional group A with a modifying agent.

The solid polymer compounds may be either those having the functional groups A, or those to which the functional groups A can be introduced. Accordingly, the solid polymer compound before reaction may be of a linear or branch structure. Further, the solid polymer compound may be either a fluoro type polymer compound or a hydrocarbon type polymer compound.

Among them, for obtaining a modified electrolyte having high electric conductivity, the solid polymer compound is preferably an aromatic hydrocarbon type polymer compound, and particularly, a whole aromatic hydrocarbon type polymer compound. Further, for obtaining a modified electrolyte having heat resistance, oxidation resistance and high electric conductivity, the solid polymer compound is preferably a fluoro polymer compound, and particularly, a perfluoro polymer compound.

The functional group A is a functional group that can be a first intermediate acid group by reacting with a functional group B of the modifying agent described later. The functional group A may be introduced to any site of the solid polymer compound. That is, the functional group A may be bonded directly to the linear solid polymer compound, or may be bonded to the intermediate portion or terminal end of the side chain constituting the solid polymer compound.

The functional group A may preferably include, a sulfunyl halide group, a sulfonamide group, sulfonamide metallic salt, an N-alkylsilylsulfonamide group, N-alkylsilylsulfonamide metallic salt, a carbonyl halide group, a carboxylate ester group, a carbonylamide group, a phosphonyl halide group, a phosphate ester group, a phosphonylamide group, a sulfonic acid group, a carboxylic acid group, a phosphonic acid group, and derivatives thereof. Particularly, the sulfonyl halide group and the derivative thereof are suitable as the functional group A, because they can be easily hydrolyzed into strong acid groups and provide the modified electrolyte with high electric conductivity even when they are not consumed in the reaction with the modifying agent.

As the functional group A, it is preferred to use a sulfonamide group obtained by reaction between a sulfonyl halide group and ammonia. In this case, the reaction ratio between the sulfonyl halide group and ammonia is preferably 20 to 100%. The reaction ratio is more preferably 30 to 100%, further preferably 50 to 100%, and particularly preferably 70 to 100%.

The solid polymer compound may contain a single kind of functional group A, or may contain plural kinds of functional group A. Further, a single kind of solid polymer compound having at least one kind of functional group A may be reacted with a modifying agent, or plural kinds of solid polymer compounds each having the identical or different functional groups A may be mixed at an arbitrary ratio, and may be reacted with the modifying agent.

The perfluoro polymer compound having the functional group A may preferably include, Nafion (registered trade mark) manufactured by E.I. duPont de Nemours and Company, Aciplex (registered trade mark) manufactured by Asahi Kasei Corp., Flemion (registered trade mark) manufactured by Asahi Glass Co. Ltd., GORE-TEX® (registered trade mark) membranes manufactured by W.L.Gore & Associates, and derivatives thereof.

The fluoro-hydrocarbon type polymer compound to which the functional group A can be introduced may preferably include, polystyrene-grafted-ethylene tetrafluoroethylene copolymer (hereinafter referred to as “ETFE-g-PS”), polytetrafluoroethylene-grafted-polystyrene, and derivatives thereof.

The aliphatic hydrocarbon type polymer compound to which the functional group A can be introduced may preferably include, polyamide, polyacetal, polyethylene, polypropylene, acrylic resin, polyester, polysulfone, polyether, and derivatives thereof.

The partial aromatic hydrocarbon type polymer compound to which the functional group A can be introduced may preferably include polystylene, polyamide, polyamide imide, polyimide, polyester, polysulfone, polyether imide, polyether sulfone, and polycarbonate having aromatic rings, as well as derivatives thereof.

The whole aromatic hydrocarbon type polymer compound to which the functional group A can be introduced may preferably include polyether ether ketone, polyether ketone, polysulfone, polyether sulfone, polyimide, polyether imide, polyphenylene, polyphenylene ether, polycarbonate, polyamide, polyamide imide, polyester, polyphenylene sulfide, and derivatives thereof.

Further, the compound which has the functional group A or to which the functional group A has been introduced (electrolyte) may be reinforced with a reinforcing material such as a porous polytetrafluoroethylene (PTFE) sheet, or fibril PTFE fibers.

There is no particular restriction on the concentration of the functional group A and the number of side chains having the functional group A in the solid polymer compound used as the starting material, and a compound having the optimum concentration or number of side chains may be used in accordance with the strength, the electric conductivity, and the like required for the modified electrolyte. Generally, the total amount of acid groups that can be introduced into the entire electrolyte increases as the concentration of the functional group A is higher, or as the number of side chains having the functional group A is larger. Accordingly, for obtaining a modified electrolyte showing high electric conductivity, higher concentration of the functional group A is preferred so long as the crystallinity of the main chain structure is not deteriorated, and it is also preferred that the number of side chains having the functional group A is larger. Specifically, the concentration of the functional group A is preferably 0.25 mmol/g or more and 10 mmol/g or less, and further preferably 0.5 mmol/g or more and 4 mmol/g or less.

Then, the modifying agent is to be explained. The modifying agent for introducing the intermediate acid group to the side chains of the solid polymer compound (hereinafter referred to as “first modifying agent”) should have at least one functional group B and at least one functional group C in one molecule.

The functional group B is a functional group capable of reacting with the functional group A in the solid polymer compound, thereby forming a first intermediate acid group. The functional group may preferably include, a sulfonyl halide group, a sulfonamide group, sulfonamide metallic salt, an N-alkylsilylsulfonamide group, N-alkylsilylsulfonamide metallic salt, a carbonyl halide group, a carboxylate ester group, a carbonylamide group, a phosphonyl halide group, a phosphate ester group, a phosphonylamide group, a sulfonic acid group, a carboxylic acid group, a phosphonic acid group, and derivatives thereof.

Particularly, the sulfonyl halide group, the carbonyl halide group, the phosphonyl halide group, the sulfonate ester group, the carboxylate ester group, and the phosphate ester group are suitable as the functional group B.

The functional group C is a functional group capable of forming a terminal acid group or a second intermediate acid group. The functional group C includes a terminal acid group or a second intermediate acid group per se, as well as those forming the terminal acid group or the second intermediate acid group by hydrolysis, substitution reaction, or the like. The functional group C may preferably include, halogen, a sulfonyl halide group, a sulfonamide group, sulfonamide metallic salt, an N-alkylsilylsulfonamide group, N-alkylsilylsufoneamide metallic salt, a carbonyl halide group, a carboxylate ester group, a carbonylamide group, a phosphonyl a halide group, a phosphate ester group, a phosphonylamide group, and derivatives thereof.

The first modifying agent having the functional groups B and C described above may preferably include, fluorosulfonyl fluoride such as: 1,1,2,2-tetrafluoroethyl-1,3-disulfonyl fluoride; 1,1,2,2,3,3-hexafluoropropyl-1,3-disulfonyl fluoride; 1,1,2,2,3,3,4,4-octafluorobutyl-1,4-disulfonyl fluoride; 1,1,2,2,3,3,4,4,5,5-perfluorobutyl-1,5-disulfonyl fluoride, or derivatives thereof.

Further, as the first modifying agent, it may also be possible to use fluorosulfonyl chloride such as: 1,1,2,2-tetrafluoroethyl-1,2-disulfonyl chloride; 1,1,2,2,3,3-hexafluoropropyl-1,3-disulfonyl chloride; 1,1,2,2,3,3,4,4-octafluorobutyl-1,4-disulfonyl chloride; 1,1,2,2,3,3,4,4,5,5-perfluorobutyl-1,5-disulfonyl chloride; and derivatives thereof, as well as 1,4-benzene disulfonyl chloride and 4,4′-biphenyldisulfonyl chloride.

Further, other specific examples of the first modifying agent may include preferably, 1,1,2,2,3,3-hexafluoropropyl-3-iodo-1-sufonyl fluoride, 1,1,2,2,3,3,4,4-octafluorobutyl-4-iodo-1-sulfonyl fluoride, and derivatives thereof.

The modifying agent for introducing the modified acid group to the side chain of the solid polymer compound (hereinafter referred to as “second modifying agent”) should have at least one functional group D and at least one functional group E.

The functional group D is a functional group capable of reacting with the first or the second intermediate acid group introduced to the side chain. The functional group D may preferably include, halide, a sulfonyl halide group, a carbonyl halide group, a phosphonyl halide group, and derivatives thereof.

Further, the functional group E is a group capable of forming a terminal acid group or a third intermediate acid group. That is, the functional group E includes a terminal acid group or a third intermediate acid group per se, as well as those forming the terminal acid group or the third intermediate acid group by hydrolysis, substitution reaction, or the like. The functional group E may preferably include, a sulfonyl halide group, a carbonyl halide group, a carboxylate ester group, a bissulfonyl imide group, a sulfonylcarbonyl imide group, a biscarbonyl imide group, halogen, and derivatives thereof.

The second modifying agent having the functional group D and the functional group E may preferably include: 1,1,2,2,3,3-hexafluoro-1,3-diiodide; 1,1,2,2,3,3,4,4-octafluoro-1,4-diiodide; and derivatives thereof.

In a case where the fluoro sulfonyl halide is used as the first modifying agent, the number of carbon atoms in the sulfonyl halide group is preferably 1 to 20. The fluoro sulfonyl halide may have a linear structure or a branch structure. Further, for providing the modified electrolyte with high electric conductivity, those having a branch structure and also having plural sulfonyl halide groups are particularly suitable.

Further, the first modifying agent may contain one kind of functional groups B and C each described above, or may contain plural kinds of functional groups B and C each. Further, a single kind of compound having at least one kind of functional groups B and C may be used as the first modifying agent, or plural kinds of compounds each having the identical or different functional groups B and C may be mixed at an arbitrary ratio and used as the first modifying agent. The same holds true with the second modifying agent.

A modified electrolyte having multifunctional side chains is obtained when the solid polymer compound having the functional group A are reacted with the first modifying agent and/or the second modifying agent under an optimal condition in accordance with a combination thereof after a pre-treatment has been applied to them as needed. Particularly, a modified electrolyte showing high electric conductivity is obtained by amidating the functional group A of the solid polymer compound, and then, by reacting the same with the modifying agent under the optimal condition.

In this case, the introduced amount of the first modifying agent and the second modifying agent, and the reaction ratios between these agents and the solid polymer compound may be selected in accordance with the electric conductivity and the mechanical characteristic required for the modified electrolyte. Generally, a modified electrolyte having higher electric conductivity is obtained as the percentage of the functional group A reacted with the modifying agent is increased.

Specifically, it is preferred to introduce a first modifying agent having at least one functional group B and at least one functional group C to a solid polymer compound having a functional group A, and then, to react 20% to 100% of the functional group A with the functional group B. The reaction ratio of the functional group A is further preferably 30 to 100%, more preferably 50 to 100%, and particularly preferably 70 to 100%.

Further, when a second modifying agent is further reacted with the reaction product between the solid polymer compound having the functional group A and the first modifying agent, the introduced amount of acid groups increases in accordance with the reaction ratio, further improving the electric conductivity.

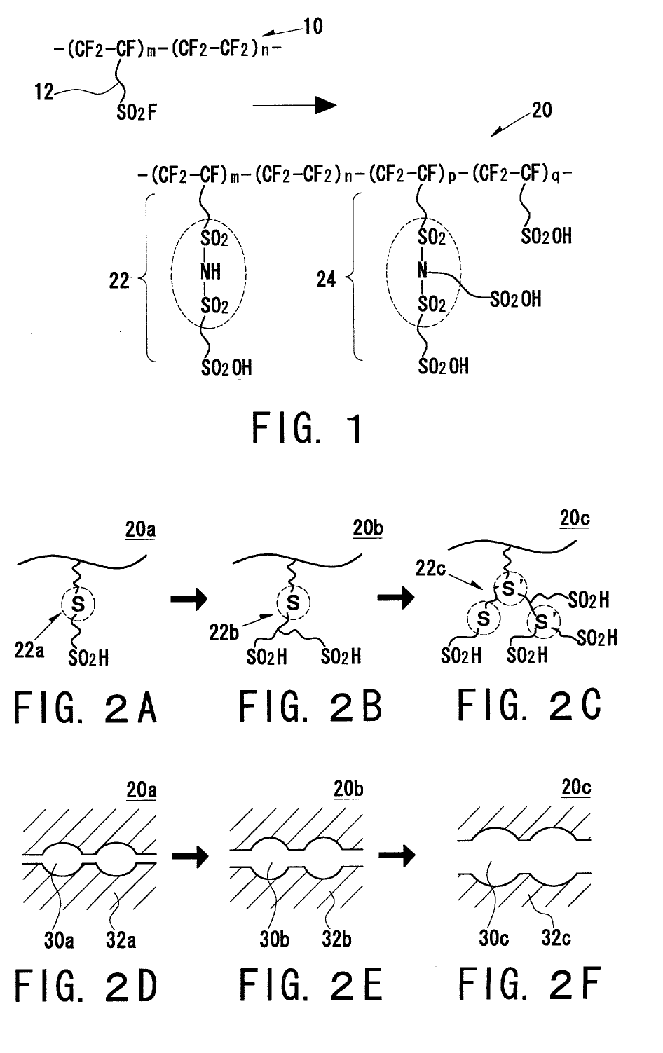

For example, as shown in FIG. 1, when a perfluoro polymer compound 10 having a sulfonyl fluoride group (functional group A) at the terminal end of a side chain 12 is reacted with a linear modifying agent having a predetermined functional group on both of its terminal ends (not illustrated) under an appropriate condition, a portion of the side chain 12 is modified into multifunctional side chains 22 and 24 to form a modified electrolyte 20.

Among them, the multifunctional side chain 22 is formed by the modification of the portion of the side chain 12 with the first modifying agent, and has two acid groups which are a sulfonic acid group (terminal acid group) and a bissulfonyl imide group (intermediate acid group). Further, the multifunctional side chain 24 is formed by further modification of the multifunctional side chain 22 with a second modifying agent, and has two acid groups which are a sulfonic acid group being the terminal acid group and a modified acid group in which hydrogen of the bissulfonyl imide group has been substituted with an atom group having a sulfonic acid group.

Then, the function of the modified electrolyte according to this embodiment is to be explained. The solid polymer electrolyte generally comprises a main chain that contributes to the strength and side chains having electrolyte groups. The electrolyte groups on the side chains are associated to form a cluster, and are joined by way of a narrow channel to form a conduction path. Accordingly, a thick conductive path has to be formed for enhancing the electric conductivity of the solid polymer electrolyte. To this end, it is necessary to increase the concentration of the electrolyte groups in the solid polymer electrolyte.

On the other hand, existent perfluoro polymer electrolyte typically represented by Nafion generally comprises a copolymer of a monomer having one electrolyte group (hereinafter referred to as “electrolyte group monomer”) and a monomer constituting a main chain. Accordingly, for increasing the concentration of the electrolyte groups contained in the perfluoro polymer electrolyte, it is necessary to increase the ratio of the electrolyte group monomers upon synthesis. However, when the ratio of the electrolyte group monomers increases, crystallinity of the main chain is lowered and the strength can no more be maintained, whereas the electric conductivity is increased.

On the contrary, as shown in FIG. 2A, when a solid polymer compound having one functional group A in the side chain is reacted with a linear modifying agent, a modified electrolyte 20a having a multifunctional side chain 22a containing a terminal acid group (sulfonic acid group) and an intermediate acid group (indicated as “S” in FIGS. 2A to 2F) is obtained. In the same manner, when the solid polymer compound and a branched modifying agent having three functional groups are reacted, an electrolyte 20b having a multifunctional side chain 22b containing two terminal acid groups and one intermediate acid group is obtained as shown in FIG. 2B. Further, when the solid polymer compound is reacted with a modifying agent having plural branches, or reacted with a modifying agent by several times repeatedly, a modified electrolyte 20c having a multifunctional side chain 22c containing a plurality of terminal acid groups, intermediate acid groups, and modified acid groups (indicated as “S′” in FIGS. 2A to 2F, meaning the intermediate acid groups which have been deprived of hydrogen) is obtained.

Schematic cross sectional views for the modified electrolytes 20a to 20c obtained in this way are shown, in FIG. 2D to FIG. 2F, respectively. Since the conduction paths 30a to 30c is thickened by the increase of the amount of acid groups, the modified electrolytes 20a to 20c show higher electric conductivity before modification. In addition, since the conduction paths 30a to 30c are thickened as the amount of acid groups introduced into the side chain increases, the electric conductivity also increases correspondingly.

On the other hand, in the modified electrolytes 20a to 20c, there is no structural change in the main chain skeletons 32a to 32c that contributes to the strength upon modification. Accordingly, the modified electrolytes 20a to 20c maintain identical strength with that before modification and are not markedly swollen or solubilized in water even if the amount of acid groups introduced to the side chain increases.

Further, when an electrolyte is synthesized by using monomers having plural acid groups in the ether moiety, there is a concern that insufficient molecular weight may be obtained because of the bulkiness of the monomer, and that the membrane strength may be insufficient. Further, since monomer of higher bulkiness is less copolymerized, there is a limit for the number of side chains (that is, the number of acid groups) introduced to per-molecule basis. On the contrary, since the modified electrolyte according to this embodiment can be produced by reacting the functional group A of the solid polymer compound and the modifying agent, the control range for the number of side chains per molecule and the number of acid groups per side chain is large. Therefore, a modified electrolyte having higher strength and higher electric conductivity not obtainable by the existent process can be obtained.

Then, a modified electrolyte and a process for producing the modified electrolyte according to a third embodiment of the present invention are to be explained. The modified electrolyte according to this embodiment comprises polymer compounds having side chains, at least one terminal acid group present at the terminal ends of the side chains, at least one intermediate acid group and/or modified acid group within the side chain identical with the side chain in which the terminal acid group is present. It further comprises a crosslinking group that crosslinks the solid polymer compounds to each other.

In this embodiment, the solid polymer compound may be crosslinked on either the main chain or the side chain. Generally, there are various methods for crosslinking polymer compounds, and crosslinking groups take various structures in accordance with the crosslinking method to be used. In this embodiment, the solid polymer compound may be crosslinked by any of the methods, and the structure of the crosslinking group has no particular restriction.

However, since the terminal acid group has higher reactivity compared with other portions, it is preferred to crosslink the solid polymer compound by way of the terminal acid group. Further, in the case of crosslinking using the terminal acid group, two terminal acid groups are consumed on every introduction of one crosslink structure into the solid polymer compound. Accordingly, for obtaining a modified electrolyte showing high electric conductivity, the solid polymer compound is preferably crosslinked by way of an acidic crosslinking group.

The acidic crosslinking group is a crosslinking group that exhibits acidity in a state of containing water. For this purpose, it is necessary that the acidic crosslinking group have a structure capable of moving electrons easily from the crosslinked point. Specifically, such includes preferably, for example, a bissulfonyl imide group, a sulfonyl carbonyl imide group and a biscarbonyl imide group. The solid polymer compound may be crosslinked by way of one kind of acidic crosslinking group or may be crosslinked by way of plural kinds of acidic crosslinking group, among them.

Generally, a modified electrolyte with excellent heat resistance is obtained as the crosslinking density increases. However, when the crosslinking density is excessive, it hinders containment of water and movement of molecules of water, rather it tends to deteriorate the proton conductivity. Accordingly, the crosslinking density may be selected to an optimal value in accordance with the heat resistance, the electric conductivity, and the like required for the modified electrolyte. The crosslinking density can be controlled specifically by adjusting the water content in the reaction solution. Generally, as the amount of water in the reaction solution increases, the crosslinking density is lowered, and the crosslinking density increases by reducing the water content as much as possible.

Further, the acidic crosslinking group and the intermediate acid group described above are alike in showing a strong acidity in the case where the group is bonded at one end or both ends to the perfluoro skeleton. Further, since the constitutions of the solid polymer compound, the terminal acid group, the intermediate acid group and the modified acid group are identical with those in the second embodiment, explanations therefor are to be omitted.

The modified electrolyte according to this embodiment can be produced by using various methods. Among them, the modified electrolyte crosslinked by way of the acidic crosslinking group can be produced by reacting the solid polymer compound having the functional group A described above and the first modifying agent described above having plural functional groups B.

After applying a pretreatment as necessary to the solid polymer compound and the modifying agent described above, when they are reacted under an optimal condition in accordance with the combination thereof, one functional group B is reacted with one functional group A, whereby a portion of the modifying agent becomes part of the multifunctional side chain. Further, each of at least two functional groups B are reacted with the functional groups A of different solid polymer compounds, whereby other modifying agents becomes part of a crosslink structure linking the solid polymer compounds to each other. In addition, the crosslinked point forms an acidic crosslinking group formed by reaction between the functional group A and the functional group B. In this case, the ratio of forming the multifunctional side chain and the acidic crosslinking group can be controlled by optimizing the reaction conditions.

For obtaining a modified electrolyte showing high strength and high electric conductivity, it is desirable that a modifying agent having plural functional groups B be introduced to a solid polymer compound having a functional group A and that 20% to 100% of the functional group A be reacted with the functional groups B. The reaction ratio of the functional group A is preferably from 30 to 100%, more preferably from 50 to 100%, and particularly preferably from 70 to 100%.

Since the modified electrolyte according to this embodiment has multifunctional side chains, it shows high strength and high electric conductivity. Further, since it has a crosslink structure linking the solid polymer compounds to each other, the flow of molecules at high temperatures is suppressed, and the high temperature creep resistance is remarkably improved. Particularly, when the solid polymer compounds are crosslinked by way of acidic crosslinking groups, since the terminal acid groups consumed by the crosslinking reaction are compensated with the acidic crosslinking groups, a modified electrolyte excellent in the strength, electric conductivity and high temperature creep resistance can be obtained.

Further, a modified electrolyte having an electric conductivity of 0.05 S/cm or more, and a creep elongation of 150% or less (test temperature: 160° C., stress added: 0.8 MPa, test time: 4 minutes) is obtained by controlling the concentration of the functional group A, the reaction ratio of the functional group A, the kinds of functional groups A and B, and the production conditions.

Further, since the modified electrolyte according to the present invention can be formed in a non-crosslinked state into a membrane and the like and then introduced with the crosslink structure, the molding is facilitated more easily compared with a method of introducing the crosslink structure upon polymerization. Further, even in the case of using a solid polymer compound which has a relatively high concentration of electrolyte groups (or having a relatively large number of side chains) and which is easily swelled or soluble in water as the starting material, the modified electrolyte can be insolubilized in water by introducing the crosslink structure. Accordingly, the degree of design freedom for the electrolyte can be improved remarkably, and various modified electrolytes with different heat resistance, strength and electric conductivity can be obtained.

### EXAMPLE

### Example 1

At first, an amine treatment of contacting an amine compound with a perfluoro polymer electrolyte was conducted in accordance with the following procedures. That is, a Nafion 112F membrane (F112: the precursor of Nafion with sulfonyl fluoride group) of 50 μm thickness and sized 1 cm×8 cm was immersed for 5 minutes in 80 ml of a flon solvent (R113) in a globe box. Then, 5 ml of a 1.0 M (mol/L) THF solution of lithium bis(trimethylsilyl)amide (hereinafter referred to as LBTMSA) as an amine compound was added under stirring to the flon solvent, and they were immersed for 15 minutes. Subsequently, the membrane was taken out and washed with R113 and THF solutions.

Subsequent procedures were conducted in air at a room temperature. At first, the obtained membrane was put in a 25% aqueous solution of sodium hydroxide, refluxed for 2 hours, and washed with water. Then, it was hydrolyzed being immersed in 6 M hydrochloric acid for 5 hours, and remaining sulfonyl chloride groups were converted into sodium sulfonate groups. Further, the membrane was immersed in 1 M sulfuric acid, refluxed for one hour, and then converted into proton type. The resultant membrane was immersed in purified water for 10 minutes, to be refluxed, washed with water, and then stored in purified water. The electrolyte membrane is referred to as Example 1.

Then, the electric conductivity of the electrolyte membrane of Example 1 thus obtained was measured by the following procedures. That is, an obtained electrolyte membrane of 1 cm width was attached to a two-terminal electric conductivity measuring cell. A platinum foil applied with platinum black plating was used for current and voltage terminals of the cell for improving the contact with the membrane.

Then, each cell was immersed in purified water, and the membrane resistance of the electrolyte membrane was measured by an AC method (10 kHz) using an LCR meter (4262A LCR METER, manufactured by YHP). The electric conductivity (σ) was determined in accordance with the following formula 1. The value for the thickness of each membrane was measured by micrometer after measuring the electric conductivity.

[Expression 1]

σ=L/(R·A)=L/(R·w·t)

where,

σ: electric conductivity (S/cm)

R: membrane resistance (Ω)

L: distance between voltage terminals (=1 cm)

A: membrane cross sectional area (cm²)

t: membrane thickness (cm)

w : membrane width (cm)

Then, a creep resistance test at 160° C. for electrolyte membrane of Example 1 was conducted by the following procedures. That is, a weight was suspended from a membrane so as to apply a load of 0.8 MPa, the membrane was exposed to an atmosphere at 160° C. and the ratio of the elongation of membrane to the initial length after 1 minute (creep elongation) was measured.

### Examples 2 to 4

Each of the membranes was treated in accordance with the same procedures as those in Example 1 except for changing the immersion time in the LBTMSA solution to 30 minutes, 1 hour and 2 hours. The electrolyte membranes are referred to as Example 2, Example 3 and Example 4, respectively. Further, measurement of the electric conductivity and evaluation of the creep resistance were conducted in the same manner as those in Example 1.

### Example 5

5 ml of a 0.1 M (mol/L) THF solution of LBTMSA was added under stirring to 80 ml of a flon solvent (R113) in which a Nafion membrane (F112) was immersed, and the membrane was immersed for 15 minutes. Then, the membrane was taken out and washed with R113 and THF solutions. Successively, a heat treatment was conducted by heating the membrane at 120° C. for 12 hours under a reduced pressure by a rotary pump. Subsequently, the membrane was treated in the same procedures as those in Example 1. The electrolyte membrane is referred to as Example 5. Further, measurement of the electric conductivity and evaluation of the creep resistance were conducted in the same manner as those in Example 1.

### Examples 6, 7

Each of the membranes was treated in accordance with the same procedures as those in Example 5 except for changing the immersion time in the LBTMSA solution to 1 hour and 2 hours. The electrolyte membranes are referred to as Example 6 and Example 7, respectively. Further, measurement of the electric conductivity and evaluation of the creep resistance were conducted in the same manner as those in Example 1.

### Comparative Example 1

For the Nafion membrane (F112), hydrolysis, proton exchange, and storage in purified water of the membrane were conducted in accordance with the same procedures as those in Example 1 except for conducting none of the amine treatment, base treatment and heat treatment. The electrolyte membrane is referred to as Comparative Example 1. Further, electric conductivity was measured in the same manner as in Example 1, and creep elongation for 8 minutes was also measured as evaluation for the creep resistance.

Table 1 shows the treatment conditions and the result of measurement of various characteristics of electrolyte membranes obtained in Examples 1 to 7 and Comparative Example 1.

TABLE 1

| | | | | | Creep |
|---|---|---|---|---|---|
| | LBTMSA | | | | Elongation |
| | Addition | LBTMSA | Heat | Electric | after |
| | Amount | Treatment | Treatment | Conductivity | 1 minute |
| Sample | (ml) | Time | Condition | (S/cm) | (%) |
| Example 1 | 5 | 15 minutes | — | 6.0 × 10⁻² | 126 |
| Example 2 | 5 | 30 minutes | — | 6.2 × 10⁻² | 68 |
| Example 3 | 5 | 1 hour | — | 2.1 × 10⁻² | 8.7 |
| Example 4 | 5 | 2 hours | — | 1.7 × 10⁻² | 4.4 |
| Example 5 | 5 | 15 minutes | 120° C. | 6.6 × 10⁻² | 21 |
| | | | 12 hours | | |
| Example 6 | 5 | 1 hour | 120° C. | 1.9 × 10⁻³ | 9.8 |
| | | | 12 hours | | |
| Example 7 | 5 | 2 hours | 120° C. | 2.4 × 10⁻³ | 2 |
| | | | 12 hours | | |
| Comparative | — | — | — | 7.14 × 10⁻² | 121 |
| Example 1 | | | | | |

Examples 1 to 4 applied only with the amine treatment by LBTMSA showed a behavior that creep elongation in one minute abruptly decreased along with an increase in the amine treatment time, which was settled substantially constant after one hour. Further, in Examples 2 to 4, the creep elongation was about 1/2 or less of Comparative Example 1, and creep resistance was improved.

On the other hand, in Examples 1, 2 in which the amine treatment time was 30 minutes or less, the electric conductivity was not lowered so much compared with Comparative Example 1. However, in Examples, 3, 4 in which the amine treatment time was 1 hour or more, the ratio of decrease in the electric conductivity was increased. From the results, it can be seen that there is less effect on an improvement in the creep resistant property when the amine treatment time is excessively short. On the other hand, it can be understood that the creep resistance property is improved, but the electric conductivity is lowered when the amine treatment time is excessively long. That is, it can be seen that the amine treatment time has to be selected within such a range as not to greatly lower the electric conductivity and as to improve the creep resistant property.

In Example 5 in which the amine treatment and the heat treatment were conducted for 15 minutes, the creep elongation was 21% which was greatly reduced compared with Example 1 in which only the amine treatment for 15 minutes was conducted. However, in Examples 6 and 7 in which the amine treatment for one hour or more and the heat treatment were conducted, the creep elongation was substantially identical with that in Examples 3 and 4 in which only the amine treatment was conducted for the identical time. That is, it can be seen that the creep elongation can be remarkably reduced when the heat treatment is conducted after the amine treatment even when the amine treatment time is relatively short.

On the other hand, electric conductivity in Examples 5, 6 and 7 are substantially identical with that in Examples 1, 3 and 4 in which only the amine treatment was conducted for the identical time, and the electric conductivity did not change remarkably depending on the absence or presence of the heat treatment.

The reason why the creep resistant property is greatly improved by conducting the amine treatment as described above is not apparent specifically, but it may be considered that either covalent or ionic crosslinking caused by the amine compound is formed in the portion of the electrolyte group or the electrolyte group precursor in the perfluoro polymer electrolyte.

That is, it may be considered that the perfluoro polymers are crosslinked to each other mainly in the state of ionic bonds in the case of conducting only the amine treatment. Further, it may be considered that the creep elongation is decreased, and the electric conductivity is lowered as the amine treatment time is longer, because more electrolyte groups or the electrolyte group precursors are consumed by the crosslinking reaction to increase the crosslinked point.

Further, it may be considered that the creep elongation is decreased by the heat treatment conducted after the amine treatment has been conducted for a short time because the heating causes covalent crosslinking between the perfluoro polymer electrolyte and the amine compound. Further, it may be considered that the electric conductivity is maintained high even after the heat treatment, because the number of electrolyte groups or the electrolyte group precursors consumed newly by heating in the crosslinking reaction is relatively small.

### Examples 8 to 11

Each of the membranes was treated in accordance with the same procedures as those in Example 5 except for changing the addition amount of the LBTMSA solution to 2.5 ml, 1.25 ml, 0.6 ml and 0.3 ml, respectively, and the immersion time to 30 minutes. Such electrolyte membranes are referred to as Example 8, Example 9, Example 10 and Example 11, respectively. Further, the electric conductivity was measured, and the creep resistance was evaluated in the same manner as in Example 1.

### Examples 12 to 15

Each of the membranes was treated in accordance with the same procedures as those in Example 5 except for changing the addition amount of the LBTMSA solution to 2.5 ml, 1.25 ml, 0.6 ml and 0.3 ml, respectively, and the immersion time to 1 hour. Such electrolyte membranes are referred to as Example 12, Example 13, Example 14 and Example 15, respectively. Further, the electric conductivity was measured, and the creep resistance was evaluated in the same manner as in Example 1.

Table 2 shows the treatment conditions and the result of measurement of various characteristics of electrolyte membranes obtained in Examples 8 to 15 and Comparative Example 1.

TABLE 2

| | | | | | Creep |
|---|---|---|---|---|---|
| | LBTMSA | | | | Elongation |
| | Addition | LBTMSA | Heat | Electric | after |
| | Amount | Treatment | Treatment | Conductivity | 1 minute |
| Sample | (ml) | Time | Condition | (S/cm) | (%) |
| Example 8 | 2.5 | 30 minutes | 120° C. | 6.3 × 10⁻² | 33 |
| | | | 12 hours | | |
| Example 9 | 1.25 | 30 minutes | 120° C. | 7.1 × 10⁻² | 63 |
| | | | 12 hours | | |
| Example 10 | 0.6 | 30 minutes | 120° C. | 7.2 × 10⁻² | 66 |
| | | | 12 hours | | |
| Example 11 | 0.3 | 30 minutes | 120° C. | 8.2 × 10⁻² | 50 |
| | | | 12 hours | | |
| Example 12 | 2.5 | 1 hour | 120° C. | 4.2 × 10⁻² | 9.8 |
| | | | 12 hours | | |
| Example 13 | 1.25 | 1 hour | 120° C. | 6.7 × 10⁻² | 29 |
| | | | 12 hours | | |
| Example 14 | 0.6 | 1 hour | 120° C. | 7.9 × 10⁻² | 60 |
| | | | 12 hours | | |
| Example 15 | 0.3 | 1 hour | 120° C. | 6.4 × 10⁻² | 59 |
| | | | 12 hours | | |
| Comparative | — | — | — | 7.14 × 10⁻² | 121 |
| Example 1 | | | | | |

In Examples 8 to 11 in which the amine treatment time was 30 minutes, the creep elongation was about 1/3 to 1/2 of Comparative Example 1 in any of the cases, and the creep resistant property was improved remarkably in each of the cases. Further, the electric conductivity increased as the addition amount of the amine compound decreased. Particularly, in Example 11, both the electric conductivity and the creep resistant property were improved remarkably compared with Comparative Example 1.

Also in Examples 12 to 15 in which the amine treatment time was 1 hour, and the addition amount of the amine compound was changed in the same manner as in Examples 8 to 11, similar trend to that in Examples 8 to 11 was observed. However, in Example 12 in which the addition amount of the amine compound was greatest, creep elongation for one minute was remarkably smaller compared with Comparative Example 1, but the electric conductivity was lowered compared with Example 8.

From the foregoing, it can be seen that both the property of the creep resistance and the electric conductivity are improved as the addition amount of the amine compound is smaller and/or the amine treatment time is shorter in the case where the condition of the heat treatment conducted after the amine treatment step is constant.

### Example 16

A 5 ml 1,4-dioxane solution including 1.0 M (mol/L) of ammonia as an amine compound was added to 80 ml of a flon solvent (R113) in which a Nafion membrane (F112) was immersed, and then the membrane was immersed for two days. Then, the membrane was taken out and washed with R113 and THF solutions. Successively, the membrane received heat treatment conducted by heating at 120° C. for 3 days under a reduced pressure by a rotary pump. Subsequently, the membrane was treated in accordance with the same procedures as those in Example 1. The electrolyte membrane is referred to as Example 16. Further, the electric conductivity was measured in the same manner as in Example 1 and creep elongation for 8 minutes was also measured for the evaluation of creep resistance.

### Examples 17 to 19

Each of the membranes was treated in accordance with the same procedures as those in Example 16 except for changing the immersion time in the ammonia solution to 5 days, 7 days and 10 days. The electrolyte membranes are referred to as Example 17, Example 18 and Example 19, respectively. Further, the electric conductivity was measured, and the creep resistance was evaluated in the same manner as in Example 16.

### Example 20

The membrane was treated in accordance with the same procedures as those in Example 16 except for changing the heat treatment time to 2 hours. The membrane was referred to as Example 20. Further, the electric conductivity was measured, and the creep resistance was evaluated in the same manner as in Example 16.

### Example 21

The membrane was treated in accordance with the same procedures as those in Example 16 except for not conducting the heat treatment. The membrane was referred to as Example 21. Further, the electric conductivity was measured, and the creep resistance was evaluated in the same manner as in Example 16.

### Example 22

A 5 ml 1,4-dioxane solution including 1.0 M (mol/L) of ammonia was added to 80 ml of a flon solvent (R113) in which a Nafion membrane (F112) was immersed, and the membrane was immersed for two days. Then, the membrane was taken out and washed with R113 and THF solutions.

Then, the membrane received a base treatment of heating at 100° C. for 5 hours in an R113 solution of 10% triethyl amine. Successively, the membrane received a heat treatment of heating at 120° C. for 2 hours under a reduced pressure by a rotary pump. Subsequently, the membrane was treated in accordance with the same procedures as those in Example 1. The electrolyte membrane is referred to as Example 22. Further, electric conductivity was measured, and the creep resistance was evaluated in the same manner as in Example 16.

Table 3 shows the treatment conditions and the result of measurement of various characteristics of electrolyte membranes obtained in Examples 16 to 22 and Comparative Example 1.

TABLE 3

| | | | | | Creep Elongation | |
|---|---|---|---|---|---|---|
| | Ammonia | Heat | Base | Electric | After 1 | After 8 |
| | Treatment | Treatment | Treatment | Conductivity | minute | minutes |
| Sample | Time | Condition | Condition | (S/cm) | (%) | (%) |
| Example 16 | 2 days | 120° C. | — | 7.55 × 10⁻² | 50 | 121 |
| | | 3 days | | | | |
| Example 17 | 5 days | 120° C. | — | 5.54 × 10⁻² | 92 | 123 |
| | | 3 days | | | | |
| Example 18 | 7 days | 120° C. | — | 4.71 × 10⁻² | 66 | 85 |
| | | 3 days | | | | |
| Example 19 | 10 days | 120° C. | — | 3.92 × 10⁻² | 80 | 92 |
| | | 3 days | | | | |
| Example 20 | 2 days | 120° C. | — | 6.18 × 10⁻² | 75 | 128 |
| | | 2 hours | | | | |
| Example 21 | 2 days | — | — | 6.18 × 10⁻² | 150 | 189 |
| Example 22 | 2 days | 120° C. | Triethyl- | 7.20 × 10⁻² | 72 | 103 |
| | | 2 hours | amine | | | |
| | | | 100° C. | | | |
| | | | 5 hours | | | |
| Comparative | — | — | — | 7.14 × 10⁻² | 121 | 189 |
| Example 1 | | | | | | |

In Examples 16 to 19 in which the conditions of the heat treatment conducted after the amine treatment were made constant while the amine treatment time was changed, creep elongation for 1 minute and 8 minutes were greatly decreased compared with Comparative Example 1, and the creep resistance was improved. Further, the electric conductivity was higher as the ammonia treating time was shorter. Particularly, in Example 16, higher electric conductivity than Comparative Example 1 was shown.

That is, it can be seen that both the creep resistant property and the electric conductivity are improved as the amine treatment time is shorter in the case where the heat treatment conducted after the amine treatment step is constant as is the case where the amine compound used is ammonia. Further, it can be understood that the optimal time for conducting the amine treatment varies depending on the kind of the amine compounds used, and that the amine treatment time has to be changed depending on the kind of the amine compound.

Further, when Examples 16, 20 and 21, in which the ammonia treatment time is identical, are compared, it can be seen that the creep elongation is decreased by the heat treatment, and the electric conductivity and creep resistant property are improved as the heat treatment time is longer.

From the foregoing, it can be seen that the electrolyte can be reformed by properly controlling the amine treatment time and the heat treatment conditions and the like in accordance with the conditions and the application use of the electrolyte so that desired electric conductivity and creep resistant property are obtained.

Further, in Example 22 in which the amine treatment, the base treatment and the heat treatment were conducted in this order, creep elongation was identical with Example 20 where the base treatment was not conducted. However, the electric conductivity was higher than Example 20 and identical with Comparative Example 1.

The reason why the electric conductivity was not lowered in the case of conducting the base treatment as described above may be considered that protons at crosslinked points are released more easily by the action of the base as a proton acceptor at the crosslinked points.

### Example 23

A suspended solution of a 5 ml THF solution including 500 mg of sodium amide as the amine compound was added to 80 ml of a flon solvent (R113) in which a Nafion membrane (F112) was immersed, and the membrane was immersed for two days. Then, the membrane was taken out and washed with R113 and THF solutions. Successively, the membrane received a heat treatment of heating at 120° C. for 2 hours under a reduced pressure by a rotary pump. Subsequently, the membrane was treated in accordance with the same procedures as those in Example 1. The electrolyte membrane is referred to as Example 23. Further, electric conductivity was measured, and the creep resistance was evaluated in the same manner as in Example 1.

### Example 24

The membrane was treated in accordance with the same procedures as those in Example 16 except for using 1 ml of 1-hexylamine as an amine compound. The electrolyte membrane is referred to as Example 24. Further, the electric conductivity was measured, and the creep resistance was evaluated in the same manner as in Example 1.

Table 4 shows the treatment conditions and the result of measurement of various characteristics of electrolyte membranes obtained in Examples 23 and 24 and Comparative Example 1.

TABLE 4

| | | | | | Creep |
|---|---|---|---|---|---|
| | | Amine | Heat | Electric | Elongation |
| | Amine | Treatment | Treatment | Conductivity | after 1 |
| Sample | Compound | Time | Condition | (S/cm) | minute (%) |
| Example 23 | Sodium | 2 days | 120° C. | 3.5 × 10⁻² | 40 |
| | Amide | | 3 days | | |
| Example 24 | 1-Hexyl | 2 days | 120° C. | 4.8 × 10⁻² | 90 |
| | Amine | | 3 days | | |
| Comparative | — | — | — | 7.14 × 10⁻² | 121 |
| Example 1 | | | | | |

In Examples 23 and 24 in which sodium amide as the metal amide and 1-hexylamine as the primary amine were used respectively as the amine compounds, the creep elongation decreased compared with Comparative Example 1 and the creep resistance was improved in the same manner as in the foregoing examples. On the other hand, the electric conductivity was lowered compared with Example 16 shown in Table 3.

In Example 16 in which ammonia as the amine compound was used, both the electric conductivity and the creep resistant property were improved compared with Comparative Example 1, and it can be seen that the ammonia is suitable as the amine compound.

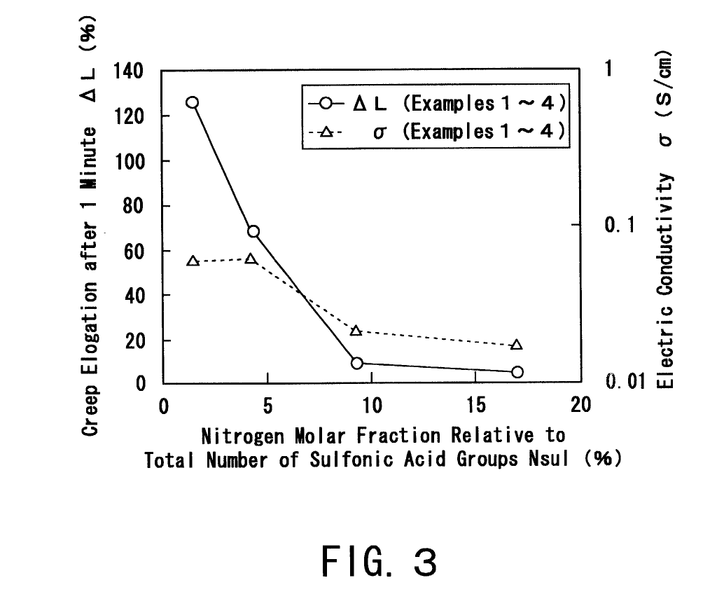

Then, elemental analysis was conducted with an aim of examining the molar fraction of the amount of nitrogen derived from the amine compound relative to the total number of sulfonic acid groups in the perfluoro polymer electrolyte. As a result, the nitrogen molar fraction relative to the total number of sulfonic acid groups Nₛᵤₗ (%) was 1.5% in Example 1, 4.2% in Example 2, 9.3% in Example 3 and 17% in Example 4. FIG. 3 shows a relation between the nitrogen molar fraction relative to the total number of sulfonic acid groups Nₛᵤₗ(%), the creep elongation for one minute and the electric conductivity.

As can be seen from FIG. 3, it exhibited a behavior that the creep elongation for one minute abruptly decreased along with increase in the nitrogen molar fraction Nₛᵤₗ(%) up to about 10% and was settled substantially constant subsequently. Further, while the electric conductivity was not lowered so much up to the nitrogen molar fraction Nₛᵤₗ(%) of about 5%, the decreasing ratio of the electric conductivity increased in excess of the molar fraction of 10%.

From the result, it can be seen that the effect on an improvement in the creep resistant property is insufficient in the case that the nitrogen molar ratio N (%) is excessively small. On the other hand, the creep resistant property is improved, but the electric conductivity is lowered in the case that the nitrogen molar fraction N(%) is excessive.

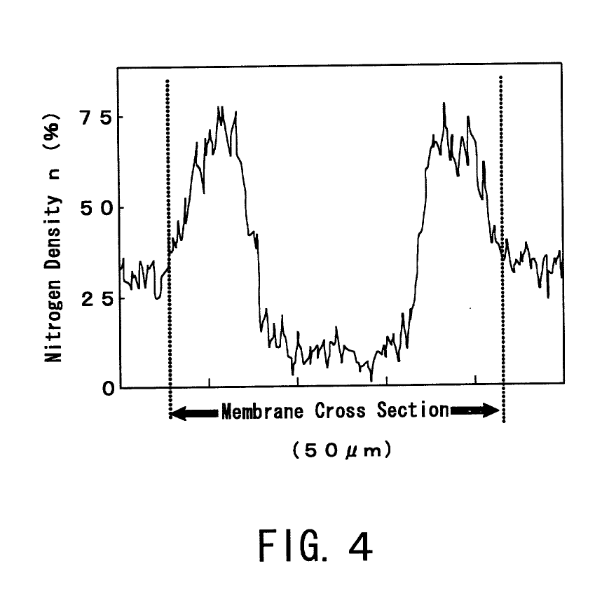

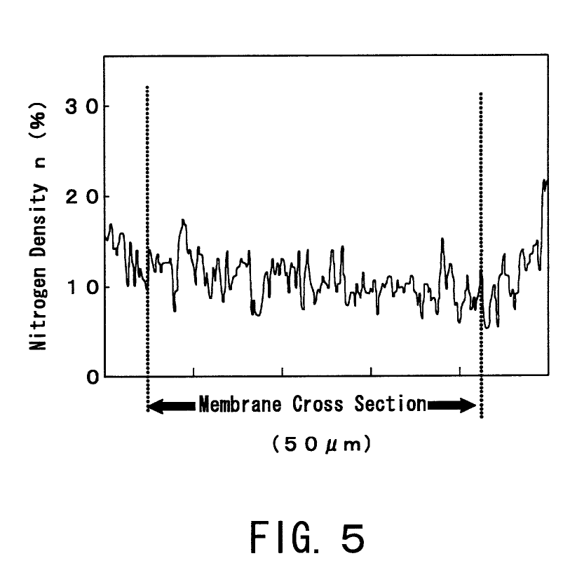

Then, description is to be made to a result of measurement of the distribution of nitrogen density n(%) on the membrane cross section (nitrogen molar ratio N(%) per unit volume). FIG. 4 shows a nitrogen density distribution on a membrane cross section in Example 4 using LBTMSA as an amine compound, and FIG. 5 shows a nitrogen density distribution on a membrane cross section in Example 17 using ammonia as an amine compound.

As shown in FIG. 4, in the membrane of Example 4, peaks of the nitrogen density n(%) are present locally on the surface of the membrane forming a nonuniform distribution. Further, the maximum value nₘₐₓ reaches as far as about 75%. On the other hand, as shown in FIG. 5, in the membrane of Example 17, distribution of the nitrogen density n(%) is uniform over the entire membrane cross section. Further, the maximum value nₘₐₓ is within a range from 10% to 20% thus showing a nitrogen density distribution quite different from that of Example 4.

This may be caused by that a reaction was taken place locally near the surface of the membrane before the amine compound diffused to the central portion of the membrane in Example 4, since LBTMSA having a diffusion rate in the perfluoro polymer electrolyte membrane is lower than the reaction rate with the perfluoro polymer electrolyte membrane is used as the amine compound.

On the other hand, it may be considered that in Example 17, the amine compound was sufficiently diffused to the central portion of the membrane, and then the reaction was taken place uniformly over the entire membrane since ammonia having a diffusion rate higher than the reaction rate is used as the amine compound.

Further, while the electric conductivity was 1.7×10⁻² (S/cm) in Example 4, it was 5.54×10⁻² S/cm in Example 17 which showed a relatively high value. It may be considered that the electric conductivity of Example 4 is lower than Example 17 because a portion where the amount of electrolyte groups showing the proton conductivity is remarkably decreased is present in the membrane. It has been found from the foregoing that the nitrogen density is preferably uniform over the membrane cross section.

### Example 31

A modified electrolyte membrane having multifunctional side chains was prepared in accordance with the following procedures. For the solid polymer compound and the modifying agent, Nafion 112F membrane (8 cm×8 cm, 50 μm thickness) shown by chemical formula (1) and 1,1,2,2,3,3-hexafluoropropyl-1,3-disulfonyl fluoride shown by the chemical formula 2 were used respectively. The wave shape line in the chemical formula 1 schematically shows the ether side chain of Nafion.

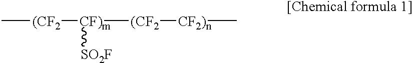

[Chemical Formula 2]

FO₂S—CF₂—CF₂—CF₂—SO₂F

At first, by sealing the Nafion 112F membrane shown by the chemical formula 1 together with an ammonia gas in a vessel and leaving at 25° C. for 2 hours, sulfonyl fluoride groups of the Nafion 112F membrane were amidized. By the ammonia gas treatment, all the sulfonyl fluoride groups in the membrane were converted into sulfonamide groups. The chemical formula 3 shows the molecular structure of the amidized Nafion 112F membrane.

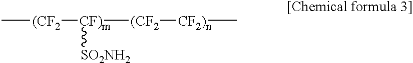

200 ml of tetrahydroxyfuran, 15 ml of triethylamine and 10 g of 1,1,2,2,3,3-hexafluoropropyl-1,3-disulfonyl fluoride shown by the chemical formula 2 (hereinafter referred to as “modifying agent solution A”) were placed in a nitrogen-substituted vessel, and an amidized Nafion 112F shown by the chemical formula 3 was immersed in the modifying agent solution A at 50° C. for 24 hours to be reacted with the Nafion 112F membrane and the modifying agent. In this example, the ratio of the sulfonamide groups in the membrane reacted with the modifying agent (reaction ratio) was 92%.

Then, the Nafion 112F membrane having been reacted was immersed in a solution of KOH/dimethylsulfoxide/water=15/35/50 at 80° C. for 8 hours to hydrolyze sulfonyl fluoride groups contained in the membrane. Further, after washing the membrane with a 10% nitric acid aqueous solution, it was washed with distilled water, and hydrolyzed sulfonyl fluoride groups were converted into the complete proton type. The chemical formula 4 shows a molecular structure of the obtained modified electrolyte membrane.

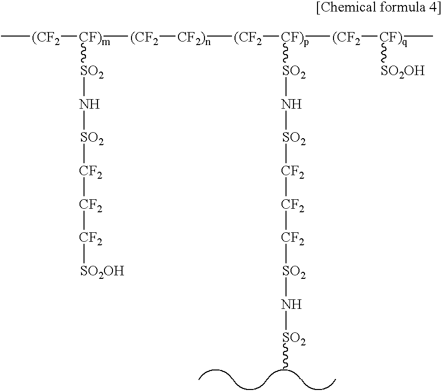

The modified electrolyte membrane obtained in this example has, as shown in the chemical formula 4, a multifunctional side chain having a sulfonic acid group (terminal acid group) and a bisulfonyl imide group (intermediate acid group), and a crosslink structure having two bissulfonylimide groups (acidic crosslinking group). The chemical formula 4 schematically shows that among the side chains contained in the Nafion 112F membrane, m side chains become a multifunctional side chain by the reaction with the modifying agent, p side chains are consumed by crosslinking with other Nafion molecules (schematically shown by the wave shape line in the chemical formula 4), and q side chains are not consumed in the reaction with the modifying agent (the letters, m, p, and q represent the numbers of the side chains).

### Example 32

A modified electrolyte membrane was prepared in accordance with the same procedures as those in Example 31 except for changing the immersion time in the modifying agent solution A to 48 hours. In this example, since the reaction time was changed to 48 hours, the reaction ratio between the modifying agent and the sulfonamide groups in the membrane was 100%.

### Example 33

A modified electrolyte membrane was prepared in accordance with the same procedures as those in Example 31 except for using a Nafion 111F membrane (8 cm×8 cm, 25 μm thickness) as the solid polymer electrolyte. In this example, the reaction ratio between the modifying agent and the sulfonamide groups in the membrane was 95%.

### Example 34

A modified electrolyte membrane was prepared in accordance with the same procedures as those in Example 31 except for using a Nafion 111F membrane (8 cm×8 cm, 25 μm thickness) as the solid polymer electrolyte and changing the immersion time in the modifying agent solution A to 48 hours. In this example, the reaction ratio between the modifying agent and the sulfonamide groups in the membrane was 100% since the reaction time was changed to 48 hours.

### Example 35

A modified electrolyte membrane having multifunctional side chains was prepared in accordance with the following procedures. A Nafion 111F membrane (8 cm×8 cm, 50 μm thickness) was used as the solid polymer compound. 1,1,2,2,3,3-hexafluoropropyl-3-iodo-1-sulfonyl fluoride shown by the following chemical formula 5 was used as the modifying agent.

[Chemical Formula 5]

FO₂S—CF₂—CF₂CF₂—I

At first, the Nafion 111F membrane was amidized in accordance with the same procedures as those in Example 31. Then, 200 ml of tetrahydrofuran, 15 ml of triethylamine and 10 g of 1,1,2,2,3,3-hexafluoropropyl-3-iodo-1-sulfonyl fluoride shown by the chemical formula (5) (hereinafter referred to as “modifying agent solution B”) were placed in a nitrogen-substituted vessel, and the amidized Nafion 111F was immersed in the modifying agent solution B at 50° C. for 48 hours to react the Nafion 111F membrane and the modifying agent. In this example, the reaction ratio between the modifying agent and the sulfonamide groups in the membrane was 100%. A chemical formula 6 shows the molecular structure of the modified Nafion 111F membrane.

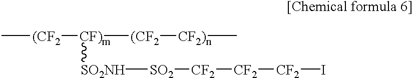

Then, the reformed Nafion 111F membrane was immersed in a reaction solution comprising 200 ml of acetonitrile, 82 g of sodium hydrogencarbonate, 100 g of sodium hydrosulfite and 300 ml of water at 40° C. for 20 hours. After the reaction, the membrane was washed with a NaCl aqueous solution, and sulfonyl sodium (—SO₂Na) was introduced to the terminal end of the side chain.

Then, the membrane was immersed in 200 ml of water, a chlorine gas was bubbled at 0° C. for 2 hours, and sulfonyl sodium was converted into sulfonyl chloride. After the reaction, the membrane was washed with an aqueous solution of sodium hydrogencarbonate. Then, the membrane was immersed in a solution of KOH/dimethylsulfoxide/water=15/35/50 at 80° C. for 8 hours, and sulfonyl chloride groups contained in the multifunctional side chains were hydrolyzed. Further, after washing the membrane with a 10% nitric acid aqueous solution, it was washed with purified water, and hydrolyzed sulfonyl chloride groups were converted into the complete proton type. A chemical formula 7 shows the molecular structure of the obtained modified electrolyte membrane.

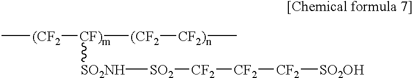

The modified electrolyte membrane obtained in this example has the multifunctional side chain having a sulfonic acid group, (terminal acid group) and a bisulfonylimide group (intermediate acid group) as shown by the chemical formula 7.

### Comparative Example 11

The Nafion 112F membrane used in Example 31 was immersed in a solution of KOH/dimethylsulfoxide/water=15/35/50 at 80° C. for 8 hours, and sulfonyl fluoride groups were hydrolyzed. Then, after washing the membrane with a 10% nitric acid aqueous solution, it was washed with distilled water to obtain a Nafion 112 membrane.

### Comparative Example 12

A Nafion membrane 111 was obtained in accordance with the same procedures as those in Comparative Example 11 except for using the Nafion 111F membrane used in Example 33.

The modified electrolyte membranes obtained in Examples 31 to 35 and Nafion membranes obtained in Comparative Examples 11 and 12 were evaluated in terms of the electric conductivity and the creep characteristic. Further, after bonding platinum carbon electrodes on both the surfaces of the resultant electrolyte membrane, fuel cells were manufactured using them, and the output characteristics were evaluated. Table 5 shows the reaction ratio with ammonia, the reaction ratio with the modifying agent, the electric conductivity, the creep elongation, and the output voltage.

TABLE 5

| | Reaction | Reaction | | | |
|---|---|---|---|---|---|
| | Ratio with | Ratio with | Electric | Creep | Output |
| | Ammonia | Modifier | Conductivity | Elongation | Voltage |
| | (%) | (%) | (S/cm) | (%) | (V) |
| Example 31 | 100 | 92 | 0.112 | 62 | 0.48 |
| Example 32 | 100 | 100 | 0.135 | 58 | 0.54 |
| Example 33 | 100 | 95 | 0.108 | 55 | 0.63 |
| Example 34 | 100 | 100 | 0.143 | 53 | 0.72 |
| Example 35 | 100 | 100 | 0.152 | 220 | 0.72 |
| Comparative | — | — | 0.078 | 300 | 0 |
| Example 11 | | | | | |
| Comparative | — | — | 0.080 | 350 | 0 |
| Example 12 | | | | | |

The electric conductivity was calculated based on the membrane resistance determined in purified water at 25° C. by an AC method (measuring frequency: 10 kHz) and a membrane thickness. Further, a stress of 0.8 MPa was given to the membrane at 160° C., and after 4 minutes, the creep characteristic was evaluated in terms of the creep elongation. Further, the output characteristic was evaluated in terms of an output voltage at a current density of 0.5 A/cm² at a cell temperature of 105° C. and a humidifying bubbler temperature of 60° C. during a steady operation under the reaction gas supply condition shown in Table 6.

TABLE 6
Evaluating Condition:
Cell Temparature 105° C., Humidifying Bubbler Temperature 60° C.

| | Cathode | Anode |
|---|---|---|
| Gas | Air | Hydrogen |
| Bubbler Temperature | 60° C. | 60° C. |
| Stoichiometry* | 1.8 | 1.2 |
| Pressure | 2ata | 2ata |

*Current Density 0.5A/cm²

In the Nafion membranes obtained by Comparative Example 11 and Comparative Example 12, the electric conductivity was less than 0.1 S/cm, and the creep elongation was 300% or more in each of the examples. Further, the fuel cell using the Nafion membrane did not operate under the low humidity high temperature condition shown in Table 6, and the output voltage was 0 V in each of the examples.

On the other hand, in the modified electrolyte Example 35 with the introduction of the multifunctional side chains only, the creep elongation was 220%, and no remarkable improvement was found in the creep resistant property compared with Comparative Example 12. However, the electric conductivity was 0.152 S/cm which was improved about twice as high as the Comparative Example 12. Further, the manufactured fuel cell operated stably even under the low humidity-high temperature condition in Table 6, and output voltage of 0.72 V was obtained.

Further, in the modified electrolyte of Example 31 to 34 with the introduction of both the multifunctional side chains and the crosslink structure, the electric conductivity was 0.1 S/cm or more in each of the examples and improved compared with Comparative Example 11. Further, the creep elongation was 53 to 62%, which was about 1/5 or less of Comparative Example 11. This is because the amount of acid group increased with the introduction of the multifunctional side chains, and the flows of molecules at high temperatures were suppressed by the polymers crosslinked via the acidic crosslinking groups.

Further, each of the cells using the membranes obtained in Examples 31 to 34 operated stably even under the low humidity-high temperature condition in Table 6, and 0.48 to 0.72 V of output voltage was obtained in accordance with the conditions of manufacturing the membranes. It is considered that the output voltage becomes higher as the reaction time with the modifying agent solution is longer because the amount of the multifunctional side chains introduced is increased as the reaction time is longer. Further, it is considered that the output voltage is higher as the thickness of the membrane is reduced because water formed at the cathode diffuses more easily toward the anode as the thickness of the membrane is reduced, and the membrane is maintained in an appropriate hydrous state.

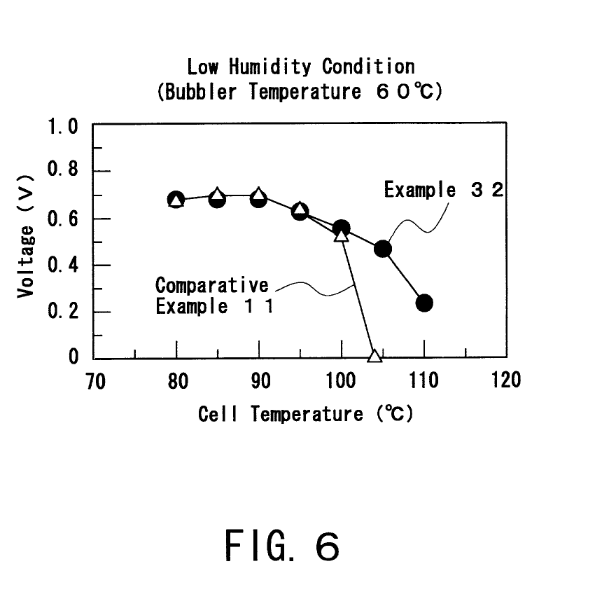

FIG. 6 shows a relation between the cell temperature and the output voltage at a current density of 0.5 A/cm² of a fuel cells using the electrolyte membranes obtained in Example 32 and Comparative Example 11. It can be seen from FIG. 6 that the output voltage lowers abruptly when the cell temperature exceeds 100° C. in Comparative Example 11, whereas the fuel cell operates stably even under the low humidity-high temperature condition in which the cell temperature exceeds 100° C. in Example 32.

### Example 36

At first, in accordance with the same procedures as those in Example 31, amidization of sulfonyl fluoride groups contained in the Nafion 112F membrane and a reaction of the amidized Nafion 112F membrane with the modifying agent solution A were conducted, and the multifunctional side chain and the crosslink structure were introduced into the membrane. After the reaction, the membrane was immersed in 200 ml of tetrahydroxyfuran and unreacted reagent was removed.

Further, for the thus obtained membrane, amidization of the sulfonyl fluoride groups contained in the membrane and the reaction between the amidized membrane and the modifying agent solution A were conducted again in accordance with the same procedures as those in Example 31. In this example, both the reaction ratio between the sulfonyl fluoride group and ammonia and the reaction ratio between the modifying agent and the sulfonamide groups in the membrane were 100%. After the reaction, the membrane was immersed in a solution of KOH/dimethylsulfoxide/water=15/35/50 at 80° C. for 8 hours, and hydrolysis was conducted. Further, after cleaning the membrane with a 10% nitric acid aqueous solution, it was further washed with distilled water to obtain a modified electrolyte membrane.

For the thus obtained modified electrolyte membrane, the electric conductivity, the creep elongation and the output characteristic were measured under the same conditions as those in Example 31. As a result, the electric conductivity was 0.165 S/cm, and the creep elongation was 49%. Further, the fuel cell using the modified electrolyte membrane operated stably under the low humidity-high temperature condition shown in Table 6, and 0.69 V of output voltage was obtained.

### Example 37

10 g of PEEK (polyether ether ketone, manufactured by Mitsui Chemical Co.) was dissolved in 100 ml of concentrated sulfuric acid and reacted at a room temperature for 100 hours. Then, the resultant liquid solution was poured into 11 of water to precipitate sulfonated PEEK (hereinafter referred to as “s-PEEK”). The precipitates were filtered and washed with water. The sulfonation ratio of the resultant s-PEEK was 80%.

Then, s-PEEK membrane of 50 μm thickness was prepared from a solution of s-PEEK in a water/ethanol solution. Then, the membrane (8 cm×8 cm) was immersed in a solution containing 30 g of thionyl chloride and 300 ml of tetrahydrofuran at 50° C. for 10 hours to chlorinate the sulfonic acid groups of the s-PEEK membrane. After the reaction, the membrane was immersed in a 300 ml solution of tetrahydrofuran to remove unreacted thionyl chloride.

Further, for the resultant membrane (8 cm×8 cm, 50 μm thickness), amidization treatment, reaction with the modifying agent solution A, hydrolysis and protonating treatment of the membrane were conducted under the same conditions as those in Example 1. In this example, both the reaction ratio between the sulfonyl chloride groups and ammonia and the reaction ratio between the modifying agent and sulfonamide groups in the membrane were 100%.

For the resultant modified electrolyte membrane, the electric conductivity, the creep elongation and the output characteristics were measured under the same conditions as those in Example 31. As a result, the electric conductivity was 0.165 S/cm, and the creep elongation was 5%. Further, the fuel cell using the modified electrolyte membrane operated stably under low humidity-high temperature condition shown in Table 6, and 0.56 V of output voltage was obtained.

### Example 38

4,4′-diamino-2,2′-biphenyl disulfonic acid and 1,4,5,8-naphthalene tetracarboxylic acid dianhydride were dissolved at a molar ratio of 1:1 into cresol and reacted at 80° C. for 10 hours to synthesize polyimide. The solution was cast to prepare polyimide membrane A of 50 μm thickness. Then, the membrane (8 cm×8 cm) was immersed in a solution of 300 ml tetrahydrofuran including 30 g of thionyl chloride at 50 ° C. for 10 hours to chlorinate the sulfonic acid groups in the polyimide membrane A. After the reaction, the membrane was immersed in a solution of 300 ml of tetrahydrofuran to remove unreacted thionyl chloride.

Further, for the obtained membrane (8 cm×8 cm, 50 μm thickness), the amidization treatment, reaction with the modifying agent solution A, hydrolysis and protonating treatment of the membrane were conducted under the same conditions as those in Example 1. In this example, both the reaction ratio between the sulfonyl chloride groups and ammonia and the reaction ratio between the modifying agent and the sulfonamide groups in the membrane were 100%.

For the resultant modified electrolyte membrane, the electric conductivity, the creep elongation and the output characteristic were measured under the same conditions as those in Example 31. As a result, the electric conductivity was 0.170 S/cm and the creep elongation was 5%. Further, the fuel cell using the modified electrolyte membrane operated stably under the low humidity-high temperature condition shown in Table 6, and output voltage of 0.55 V was obtained.

### Example 39

4,4′-diamino-2,2′-biphenyl disulfonic acid, 4,4′-(9-fluorenylidenediamine) and 1,4,5,8-naphthalene tetracarboxylic acid dianhydride were dissolved at a molar ratio of 0.95:0.05:1 into cresol and reacted at 80° C. for 10 hours to synthesize a polyimide. The solution was cast to prepare a polyimide membrane B of 50 μm thickness. Then, the obtained membrane (8 cm×8 cm) was immersed in a solution of 300 ml tetrahydrofuran including 30 g of thionyl chloride at 50° C. for 10 hours to chlorinate the sulfonic acid groups in the polyimide membrane B. After the reaction, the membrane was immersed in a 300 ml solution of tetrahydrofuran to remove unreacted thionyl chloride.

Further, for the obtained membrane (8 cm×8 cm, 50 μm thickness), the amidization treatment, reaction with the modifying agent solution A, hydrolysis and the protonating treatment of the membrane were conducted under the same conditions as those in Example 1. In this example, both the reaction ratio between the sulfonyl chloride groups and ammonia and the reaction ratio between the modifying agent and the sulfonamide groups in the membrane were 100%.

For the obtained modified electrolyte membrane, the electric conductivity, the creep elongation and the output characteristic were measured under the same conditions as those in Example 31. As a result, the electric conductivity was 0.175 S/cm, and the creep elongation was 6%. Further, the fuel cell using the modified electrolyte membrane operated stably under the low humidity-high temperature condition shown in Table 6, and output voltage of 0.56 V was obtained.

### Example 40

4,4′-diamino-2,2′-biphenyl disulfonic acid, 4,4′-oxydianiline and 1,4,5,8-naphthalene tetracarboxylic acid dianhydride were dissolved at a molar ratio of 0.95:0.05:1 into cresol and reacted at 80° C. for 10 hours to synthesize a polyimide. The solution was cast to prepare a polyimide membrane C of 50 μm thickness. Then, the membrane (8 cm×8 cm) was immersed in a solution of 300 ml tetrahydrofuran including 30 g of thionyl chloride at 50° C. for 10 hours to chlorinate the sulfonic acid groups in the polyimide membrane C. After the reaction, the membrane was immersed in a 300 ml solution of tetrahydrofuran to remove unreacted thionyl chloride.

Further, for the obtained membrane (8 cm x 8 cm, 50 μm thickness), the amidization treatment, reaction with the modifying agent solution A, hydrolysis and the protonating treatment of the membrane were conducted under the same conditions as those in Example 31. In this example, both the reaction ratio between the sulfonyl chloride groups and the ammonia and the reaction ratio between the modifying agent and the sulfonamide groups in the membrane were 100%.

For the obtained modified electrolyte membrane, the electric conductivity, the creep elongation and the output characteristic were measured under the same conditions as those in Example 31. As a result, the electric conductivity was 0.176 S/cm, and the creep elongation was 7%. Further, the fuel cell using the modified electrolyte membrane operated stably under the low humidity-high temperature condition shown in Table 6 and output voltage of 0.55 V was obtained.

### Example 41

An ETFE membrane (ethylene-tetrafluoroethylene copolymer, 8 cm×8 cm, 50 μm thickness) irradiated with electron rays were immersed in a solution comprising 588 ml of styrene, 12 ml of divinyl benzene and 300 ml of xylene at 60° C. for 5 hours to obtain an ETFE-grafted-polystyrene membrane. The graft ratio was 45%. The membrane was immersed in a solution comprising 20 ml of chlorosulfonic acid and 500 ml of dichloroethane at 60° C. for one hour to sulfonate a polystyrene portion. Subsequently, the membrane was immersed in 500 ml of dichloro ethane to remove unreacted reagent.

Further, for the obtained membrane (8 cm×8 cm, 50 μm thickness), the amidization treatment for the membrane, reaction with the modifying agent solution A, hydrolysis and the protonating treatment were conducted under the same conditions as those in Example 31. In this example, both the reaction ratio between the sulfonyl chloride groups and ammonia and the reaction ratio between the modifying agent and the sulfonamide groups in the membrane were 100%.

For the obtained modified electrolyte membrane, the electric conductivity, the creep elongation and the output characteristic were measured under the same conditions as those in Example 31. As a result, the electric conductivity was 0.190 S/cm, and the creep elongation was 3%. Further, the fuel cell using the modified electrolyte membrane operated stably under the low humidity-high temperature condition shown in Table 6 and output voltage of 0.50 V was obtained.

### Comparative Example 13

For the s-PEEK membrane (50 μm thickness) synthesized in Example 37, the electric conductivity, the creep elongation and the output characteristic were measured under the same conditions as those in Example 31. As a result, the electric conductivity was 0.105 S/cm, and the creep elongation was 15%. Further, the fuel cell using the membrane did not operate under the low humidity-high temperature condition in Table 6, and no output voltage was obtained.

### Comparative Example 14

For the polyimide membrane A (50 μm thickness) synthesized in Example 38, the electric conductivity, the creep elongation and the output characteristic were measured under the same conditions as those in Example 31. As a result, the electric conductivity was 0.115 S/cm, and the creep elongation was 10%. Further, the fuel cell using the membrane did not operate under the low humidity-high temperature condition in Table 6, and no output voltage was obtained.

### Comparative Example 15

For the polyimide membrane B (50 μm thickness) synthesized in Example 39, the electric conductivity, the creep elongation and the output characteristic were measured under the same conditions as those in Example 31. As a result, the electric conductivity was 0.120 S/cm, and the creep elongation was 10%. Further, the fuel cell using the membrane did not operate under the low humidity-high temperature condition in Table 6, and no output voltage was obtained.

### Comparative Example 16

For the polyimide membrane C (50 μm thickness) synthesized in Example 40, the electric conductivity, the creep elongation and the output characteristic were measured under the same conditions as those in Example 31. As a result, the electric conductivity was 0.121 S/cm, and the creep elongation was 12%. Further, the fuel cell using the membrane did not operate under the low humidity-high temperature condition in Table 6, and no output voltage was obtained.

### Comparative Example 17

For the sulfonated ETFE-G-PS membrane(50 μm thickness) synthesized in Example 41, the electric conductivity, the creep elongation and the output characteristic were measured under the same conditions as those in Example 31. As a result, the electric conductivity was 0.135 S/cm, and the creep elongation was 10%. Further, the fuel cell using the membrane did not operate under the low humidity-high temperature condition in Table 6, and no output voltage was obtained.

Table 7 shows the reaction ratio of the membranes obtained in Examples 36 to 41 and Comparative Examples 13 to 17with ammonia, the reaction ratio of the membrane with the modifying agent, the electric conductivity, the creep elongation, and the output voltage.

TABLE 7

| | Reaction | Reaction | | | |
|---|---|---|---|---|---|
| | Ratio with | Ratio with | Electric | Creep | Output |
| | Ammonia | Modifier | Conductivity | Elongation | Voltage |
| | (%) | (%) | (S/cm) | (%) | (V) |
| Example 36 | 100 | 100 | 0.165 | 49 | 0.69 |
| Example 37 | 100 | 100 | 0.165 | 5 | 0.56 |
| Example 38 | 100 | 100 | 0.170 | 5 | 0.55 |
| Example 39 | 100 | 100 | 0.175 | 6 | 0.56 |
| Example 40 | 100 | 100 | 0.176 | 7 | 0.55 |
| Example 41 | 100 | 100 | 0.190 | 3 | 0.50 |
| Comparative | — | — | 0.105 | 15 | 0 |
| Example 13 | | | | | |
| Comparative | — | — | 0.115 | 10 | 0 |
| Example 14 | | | | | |
| Comparative | — | — | 0.120 | 10 | 0 |
| Example 15 | | | | | |
| Comparative | — | — | 0.121 | 12 | 0 |
| Example 16 | | | | | |
| Comparative | — | — | 0.135 | 10 | 0 |
| Example 17 | | | | | |

### Example 42

A modified electrolyte was prepared in accordance with the same procedures as those in Example 34 except for changing the treatment time with the ammonia gas to 45 minutes and changing the conversion ratio from sulfonyl fluoride groups to sulfonamide groups (reaction ratio with ammonia) to 72%.

### Example 43

A modified electrolyte was prepared in accordance with the same procedures as those in Example 34 except for changing the treatment time with the ammonia gas to 30 minutes and changing the conversion ratio from sulfonyl fluoride groups to sulfonamide groups to 51%.

### Example 44

A modified electrolyte was prepared in accordance with the same procedures as those in Example 34 except for changing the treatment time with the ammonia gas to 15 minutes and changing the conversion ratio from sulfonyl fluoride groups to sulfonamide groups to 30%.

### Example 45

A modified electrolyte was prepared in accordance with the same procedures as those in Example 34 except for changing the treatment time with the ammonia gas to 10 minutes and changing the conversion ratio from sulfonyl fluoride groups to sulfonamide groups to 20%.

### Example 46

A modified electrolyte was prepared in accordance with the same procedures as those in Example 34 except for using a fluoro material of a perfluoro electrolyte membrane reinforced with a porous PTFE sheet (membrane thickness; 30 μm, manufactured by W.L.Gore & Associates) as an electrolyte membrane. In this example, both the reaction ratio with ammonia and the reaction ratio with the modifying agent were 100%.

### Example 47

A modified electrolyte was prepared in accordance with the same procedures as those in Example 34 except for using tri(3-fluorosulfonyl-hexafluoropropyl)amine(N(CF₂CF₂CF₂SO₂F)₃)as the modifying agent. In this example, both the reaction ratio with ammonia and the reaction ratio with the modifying agent were 100%.

### Comparative Example 18

As the electrolyte membrane, a perfluoroelectrolyte membrane reinforced with a porous PTFE sheet (membrane thickness; 30 μm manufactured by W.L.Gore & Associates) was used for the experiment as it was.

For the membranes obtained in Examples 42 to 47 and Comparative Example 18, the electric conductivity, the creep elongation and the output characteristic were measured under the same conditions as those in Example 31. Table 8 shows the reaction ratio with ammonia, the reaction ratio with the modifying agent, the electric conductivity, the creep elongation, and the output voltage.

TABLE 8

| | Reaction | Reaction | | | |
|---|---|---|---|---|---|
| | Ratio with | Ratio with | Electric | Creep | Output |
| | Ammonia | Modifier | Conductivity | Elongation | Voltage |
| | (%) | (%) | (S/cm) | (%) | (V) |
| Example 42 | 72 | 100 | 0.128 | 85 | 0.68 |
| Example 43 | 51 | 100 | 0.118 | 104 | 0.63 |
| Example 44 | 30 | 100 | 0.107 | 124 | 0.52 |
| Example 45 | 20 | 100 | 0.095 | 150 | 0.42 |
| Example 46 | 100 | 100 | 0.135 | 20 | 0.69 |
| Example 47 | 100 | 100 | 0.165 | 64 | 0.75 |
| Comparative | — | — | 0.075 | 25 | 0 |
| Example 18 | | | | | |

It can be seen from Examples 42 to 45 that the electric conductivity increases, and the creep elongation decreases as the treatment time with the ammonia gas is longer in a case of reacting the Nafion 111F and the ammonia gas. This may be attributable to that the conversion ratio of the sulfonyl fluoride groups in the membrane to the sulfonamide groups increases as the treatment time with the ammonia gas is longer, whereby more multifunctional side chains and the crosslinking groups are introduced into the membrane. Further, the fuel cells using the membranes operated stably under low humidity-high temperature conditions shown in Table 6 and an output voltage from 0.42 to 0.68 V was obtained in accordance with the preparation conditions of the membranes.

On the other hand, in the perfluoro polymer electrolyte membrane reinforced with the porous PTFE sheet (Comparative Example 18), the electric conductivity was 0.075 S/cm and the creep elongation was 25%. The fuel cells using the membranes did not operate under the low humidity-high temperature conditions shown in Table 6, and no output voltage was obtained.

On the contrary, in Example 46 in which multifunctional side chains were introduced to the electrolyte membrane of Comparative Example 18, the electric conductivity was 0.135 S/cm, and the creep elongation was 20%. Both were improved compared with Comparative Example 18. Further, the fuel cells using the membranes operated stably under low humidity-high temperature conditions and 0.69 V of output voltage was obtained.

Further, in Example 47 in which tri(3-fluorosulfonyl-hexafluoropropyl)amine(N(CF₂CF₂CF₂SO₂F)₃) was used as the modifying agent, the creep elongation was 64%, which was about equal to Example 34, but the electric conductivity was 0.165 S/cm which was improved compared with Example 34. It may be considered that since the tri-functional reagent having three sulfonyl fluoride groups was used as the modifying agent, the amount of acid groups introduced per one side chain was increased. Further, the fuel cell using the membrane operated stably under the low humidity-high temperature condition shown in Table 6 and an output voltage of 0.75 V was obtained.

The present invention is not restricted at all to the embodiments described above but may be modified variously. Its modifications and variations are encompassed within the scope of the present invention so long as they have identical technical ideas with those of the present invention.

For example, the process for producing the modified electrolyte according to the second and the third embodiments of the present invention has a feature in reacting a solid polymer compound having a relatively small number of functional groups A with a modifying agent thereby forming multifunctional side chains to increase the number of acid groups in the entire electrolyte. Accordingly, by applying the process according to the present invention, it is possible to produce a solid polymer electrolyte having not only the multifunctional side chains but also side chains having two or more intermediate acid groups alone.

Further, in the embodiments described above, while the method of using a predetermined modifying agent has been explained as a process for producing a modified electrolyte having multifunctional side chains and a crosslink structure, the method of introducing the crosslink structure is not restricted thereto. For example, after introducing the multifunctional side chains into the solid polymer compound by using a modifying agent, the electrolyte may be reacted with a usual crosslinker (for example, a UV-curing type amine crosslinker) thereby introducing a crosslink structure.

Further, while the modified electrolyte according to the present invention is suitable as an electrolyte for use in electrochemical devices used under severe conditions such as fuel cells or SPE devices, the application use of the present invention is not restricted to the fuel cell or the SPE electrolysis device, but it can be also used as an electrolyte for use in various types of electrochemical devices such as a halogen hydracid electrolysis device, a sodium chloride electrolysis device, a hydrogen and/or oxygen concentrator, a humidity sensor and a gas sensor.

The foregoing description of the preferred embodiments of the invention has been presented for purposes of illustration and description. It is not intended to be exhaustive or to limit the invention to the precise form disclosed, and modifications and variations are possible in the light of the above teachings or may be acquired from practice of the invention. The embodiments chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. A process for producing a modified electrolyte comprising an amine treatment step of contacting a solid polymer electrolyte or a precursor thereof with an amine compound.

2. The process for producing the modified electrolyte according to claim 1, further comprising a heat treatment step of heating the solid polymer electrolyte or the precursor thereof after the amine treatment step.

3. The process for producing the modified electrolyte according to claim 1, further comprising a base treatment step of contacting the solid polymer electrolyte or the precursor thereof, with a base after the amine treatment step.

4. The process for producing the modified electrolyte according to claim 2, further comprising a base treatment step of contacting the solid polymer electrolyte or the precursor thereof, with a base after the amine treatment step.

5. The process for producing the modified electrolyte according to claim 1, wherein the solid polymer electrolyte is a perfluoro polymeric electrolyte.

6. The process for producing the modified electrolyte according to claim 1, wherein the amine compound is at least one compound selected from the group consisting of ammonia, alkali metal bis(trimethylsilyl)amide, sodium amide, 1-hexylamine, ethylamine, propylamine, butylamine, pentylamine, heptylamine, nonylamine, decylamine, perfluoromethylamine, perfluoroethylamine, perfluorobutylamine, perfluoropentylamine and perfluoroheptylamine.

7. The process for producing the modified electrolyte according to claim l, wherein the amine compound has a diffusion rate in the solid polymer electrolyte or the precursor thereof which is higher than the reaction rate with the solid polymer electrolyte or the precursor thereof.

8. The process for producing the modified electrolyte according to claim 1, wherein the base is at least one compound selected from the group consisting of:
trimethylamine, triethylamine, pyridine, DBU (1,8-diazabicyclo[5.4.0]-7-undecane) and DBN (1,5-diazabicyclo[4.3.0]non-5-ene);
sodium hydroxide, lithium hydroxide, calcium hydroxide, aluminum hydroxide, potassium hydroxide, sodium carbonate, potassium carbonate, sodium hydrogencarbonate and sodium alkoxide;
sodium hydride, potassium hydride, calcium hydride, lithium aluminum hydride, sodium borohydride; and
butyl lithium, sodium cyclopentadienide and phenyl lithium.

9. The modified electrolyte obtained using the process according to claim 1.

10. An electrochemical device using the modified electrolyte according to claim 9.

11. A solid polymer electrolyte fuel cell using the modified electrolyte according to claim 9.

12. The modified electrolyte obtained using the process according to claim 2.

13. An electrochemical device using the modified electrolyte according to claim 12.

14. A solid polymer electrolyte fuel cell using the modified electrolyte according to claim 12.

15. The modified electrolyte obtained using the process according to claim 3.

16. An electrochemical device using the modified electrolyte according to claim 15.

17. A solid polymer electrolyte fuel cell using the modified electrolyte according to claim 15.

18. The modified electrolyte obtained using the process according to claim 4.

19. An electrochemical device using the modified electrolyte according to claim 18.

20. A solid polymer electrolyte fuel cell using the modified electrolyte according to claim 18.

21. A process for producing a modified electrolyte comprising a first step of:
introducing, to a solid polymer compound having a functional group A, a first modifying agent comprising at least one functional group B capable of reacting with the functional group A thereby forming a first intermediate acid group and at least one functional group C capable of forming a terminal acid group or a second intermediate acid group; and
reacting the functional group A with the functional group B.

22. The process for producing the modified electrolyte according to claim 21, wherein the process further comprises a second step of:
introducing, to the solid polymer compound having been reacted with the first modifying agent, a second modifying agent comprising at least one functional group D capable of reacting with the first or second intermediate acid group and at least one functional group E capable of forming a terminal acid group or a third intermediate acid group; and
reacting the first or second intermediate acid group with the functional group D.

23. A modified electrolyte comprising:
a solid polymer compound having side chains;
at least one terminal acid group present at terminal ends of the side chains; and
at least one intermediate acid group and/or modified acid group present within the side chains identical with the side chains containing the terminal acid group.

24. The modified electrolyte according to claim 23, wherein the intermediate acid group is at least one selected from the group consisting of a bissufonyl imide group, a sulfonyl carbonyl imide group, and a biscarbonyl imide group.

25. The modified electrolyte according to claim 23, wherein, the terminal acid group is at least one selected from the group consisting of a sulfonic acid group, a carboxylic acid group, and a phosphonic acid group.

26. The modified electrolyte according to claim 23, wherein the solid polymer compound is a perfluoro polymeric compound.

27. The modified electrolyte according to claim 23, wherein a crosslinking group for crosslinking the solid polymer compounds is further provided.

28. The modified electrolyte according to claim 27, wherein the crosslinking group is at least one selected from the group consisting of a bissulfonyl imide group, a sulfonyl carbonyl imide group, and a biscarbonyl imide group.

29. The modified electrolyte according to claim 23, wherein the electroconductivity is 0.05 S/cm or higher.

30. The modified electrolyte according to claim 23, wherein the creep elongation formed by applying 0.8 MPa of stresses at 160° C. for 4 minutes is 150% or less.

31. The modified electrolyte according to claim 23, wherein the modified electrolyte is obtained by:
introducing, to the solid polymer compound having a functional group A, a first modifying agent comprising at least one functional group B capable of reacting with the functional group A thereby forming a first intermediate acid group and at least one functional group C capable of forming the terminal acid group or a second intermediate acid group; and
reacting 20% to 100% of the functional group A with the functional group B.

32. The modified electrolyte according to claim 31, wherein the functional group A is a sulfonamide group, and
the functional group B is at least one selected from the group consisting of a sulfonyl halide group, a carbonyl halide group, a phosphonyl halide group, a sulfonate ester group, a carboxylate ester group, and a phosphonate ester group.

33. An electrochemical device using the modified electrolyte according to claim 23.

34. A solid polymer electrolyte fuel cell using the modified electrolyte according to claim 23.

35. An electrochemical device using the modified electrolyte according to claim 27.

36. A solid polymer electrolyte fuel cell using the modified electrolyte according to claim 27.
